(19) United States
(12) Patent Application Publication
(10) Pub. No.: US 2026/0097765 A1
(43) Pub. Date: Apr. 9, 2026

(54) ADAPTIVE CRUISE SPEED CONTROL ASSISTANT SYSTEMS AND METHODS THEREOF

(71) Applicant: SAINT SITA RAM INNOVATION LAB PVT LTD, Bathinda (IN)

(72) Inventors: Lalit Mohan, Bathinda (IN); Chirag Sharma, Bathinda (IN)

(21) Appl. No.: 19/369,645

(22) Filed: Oct. 27, 2025

(51) Int. Cl. B60W 30/14; B60H 1/00; B60R 16/023; B60W 50/14; G01C 21/34; G01C 21/36

(52) U.S. Cl. CPC B60W 30/143; B60H 1/00764; B60R 16/0231; B60W 50/14; G01C 21/3461; G01C 21/3469; G01C 21/3608; B60W 2050/146; B60W 2510/18; B60W 2510/244; B60W 2510/30; B60W 2520/10; B60W 2530/10; B60W 2530/13; B60W 2530/20; B60W 2530/209; B60W 2540/049; B60W 2540/21; B60W 2540/215; B60W 2554/406; B60W 2555/20; B60W 2555/60; B60W 2556/50; B60W 2720/10

(57) ABSTRACT

The present disclosure relates adaptive cruise speed control assistant systems and methods thereof provide automatic and manual control of cruise speed and optimizes Range, Mileage, Fuel cost per km, Vehicular pollution, Fuel refill cost and travel time in different geographical areas depending on the vehicle characteristics, number of passengers, Tyre pressure, Air conditioning status, Use of vehicle & Load on vehicle.

### FIELD OF INVENTION

The present disclosure generally relates to the field of automobiles, more specifically the present disclosure relates to adaptive cruise speed control assistant system and a method thereof.

### BACKGROUND OF THE DISCLOSURE

Cruise control is a smart well-known feature in existing vehicles which enables maintaining a set speed without using an accelerator unless manually override by a driver through clutch, brake or other manual operation. Once a particular speed is selected, driver can take his/her foot off the accelerator and the vehicle cruises at the selected speed. Recent upgradation in the cruise control is “adaptive” cruise control (ACC) in latest vehicles. The ACC is further advancement of the conventional cruise control in a way that the adaptive cruise control automatically adjusts the speed of the vehicle to match the speed of a preceding vehicle of the vehicle. The ACC automatically matches the speed of the running vehicle automatically if the preceding vehicle slows down. Such a system uses sensors and radar to monitor the distance between the preceding vehicle and the running vehicle. Advanced ACC which is known as advanced driver assistance system (ADAS) involves resetting of cruise speed automatically once the foot is taken off the accelerator and cruise control is activated.

There are many conventional arts which disclose various systems and methods related to adaptive speed cruise control or ACC. In one of the conventional arts, automatic control of speed for a vehicle is based on using speed setting, actual speed, acceleration and the change of the slope of the road to set fuel flow for improved fuel mileage. However, such a system tends to optimize the fuel mileage depending upon one factor only i.e. slope of the road. There are other factors as well which contribute to range and mileage of the vehicle.

Range is distance covered by a vehicle for a given fuel volume or charge for the vehicle. In the conventional arts, range is predicted primarily on the basis of past driving history of the user. Some vehicles use eco mode to get better range.

Mileage is distance covered per unit fuel or electric charge (km/litre or km/Kwhr). Various factors include engine capacity, sitting capacity, load capacity affect mileage of the vehicle. One of the conventional arts introduce mileage predicting and optimization system for a normal vehicle lacking ACC. However, such a system is dependent only on tyre pressure and lack other aforementioned factors which also contribute to range and mileage considerably.

More factors including such as but not limited to speed, number of passengers sitting, goods load, tyre pressure, air conditioning, use of vehicle till date, and so on also affect the range and mileage considerably when the vehicle is in running condition and is on road. Previous driving history of the vehicle is used to predict the range (distance to be covered) with the available fuel in conventional prior arts. If the conditions vary, predicted range is very inaccurate and user runs out of fuel midway. Range and mileage prediction is being done conventionally without taking into account number of passengers, tyre pressure, use life of vehicle, load on vehicle, Air Conditioning status, and so on.

For declaring range, different speed cycles are used and vehicle is tested on a test track with different speeds. User is not informed about range at constant speed i.e. at cruise speed with different passenger load, tyre pressure etc.

Range, speed, mileage, cost/km are dealt independently. Correlation between such parameters is not fully utilised to help the user take informed decisions regarding optimisation of Range, speed, mileage, cost/km, Fuel volume/km.

Coordination between the vehicles to exchange goods/passengers is being done manually in isolation without considering Range, cost/km or fuel refill cost.

Travel time and distance advisories are based on average traffic speed predictions. User is not informed about cruise speed settings to attain higher range, fuel cost/km goals along with meeting “Just IN” and “Just Out Time” in given geographical area.

Alternate routes distance & time information is available to user for same start and end location. Fuel Running Cost and fuel refill cost on alternate routes as per vehicle make and model is not available to user.

For example, A user sets Range goal as 100 km, and Adaptive cruise speed setting is 90 Km/hr. Suppose, fuel tank contains 10 litres of fuel, then mileage is 10 km/litre at speed 90 km/hr while mileage is 12 km/litre at speed 80 km/hr. Range is 100 km at speed 90 km/hr and range is 120 km at speed 80 km/litre. Then, the Adaptive cruise speed setting can be modified to 80 Km/hr and Range goal can be modified to 120 km, which is as per speed vs Range characteristics (or graph) of vehicle under standard conditions with a given fuel/charge in vehicle. Thus, there is requirement to command automatic modification of Adaptive cruise speed setting depending upon the ‘Range’ goal. Similarly, modification can be done considering ‘Mileage’ as goal. Range and mileage prediction can also be modified by taking into account number of passengers, tyre pressure, use life of vehicle, load on vehicle, Air Conditioning status, and so on.

In another example, a user sets fuel cost/km goal as INR 9/km, cruise speed setting as INR 90 Km/hr. However, the fuel cost varies in different geographical regions. Thus, there can be requirement to modify the adaptive cruise speed setting depending upon the variable fuel cost/km. Similarly, modification can be done depending upon fuel volume/km i.e. volume of fuel in the fuel tank or amount of charge of battery in electric vehicle or volume of CNG in CNG cylinder of the vehicle. Furthermore, there can be modification in the adaptive cruise speed setting depending upon setting low fuel volume/km to save environment.

There is need to have a system which can adapt to cruise speed as per Travel distance & time restrictions compliance in different geographical areas of user. User wants to set “Travel distance & time restrictions” as a goal. For example, a user has a cruise speed setting of 90 Km/hr. As per local traffic laws, the user must cross forest area of 100 km within 1 hour as exit is not allowed after 1 hour of his entry time. Length of the route is 100 km. User cruise speed setting is 90 Km/hr. However, there is need of a system to modify adaptive cruise speed as 100 km/hr to cross the area. This is as per compliance of local traffic or other laws of the given geographic area. In another example, the adaptive cruise setting requires modification as per closing and opening gate timings of a particular zone. In another example, an aeroplane is moving at cruise speed of 1000 km/hr and landing runway is 800 km away. Runway may be available for landing after 1 hr only. So, there may be requirement to modify the adaptive cruise speed to 800 km/hr to avoid traffic congestion in air space near airport, reduce load on Air Traffic control system, avoid mid-air collision and reduce pollution near airports. Similarly, for trains approaching a railway station, vehicles approaching a charging station for EV charging, vehicles approaching fuel station or gas station, buses approaching a bus stand, ships approaching a sea port, and so on.

There is need of the system to inform, train and assist the user to use the vehicle at optimum speed to reduce fuel cost/km, reduce pollution, to refill/charge vehicle as per the geographical constraints forecast and to achieve other goals through audio/video instructions.

There is a need to adapt to new cruise speed automatically/manually to reach just in/out time in a charging station to optimise waiting period or optimise charging cost wherever charging cost varies with Time of the Day (TOD) or parking cost is variable or reduce pollution or reduce traffic or reduce number of accidents.

There is need to adapt to new cruise speed automatically/manually with an objective to coordinate between two or more vehicles and their control room to optimise waiting period or optimise charging cost wherever charging cost varies with Time of the Day (TOD) or parking cost is variable or reduce pollution or reduce traffic or reduce number of accidents.

There is need to adapt to new cruise speed automatically/manually with an objective to determine fuel costing as per geographic area, for example, the fuel costing varies from one state to another state. In such a scenario, the user may be beneficial as he may decide for example if he should purchase fuel from a particular state or wait to reach to next state basis low fuel price.

The existing systems lack assisting the adaptive cruise speed control systems to modify automatically depending upon one or more goals in terms of Range (in Km), Mileage (Km/litre), Fuel cost/km (INR/litre), Fuel volume/km, Travel distance & time restrictions compliance in different geographical areas.

Therefore, there requires a need for the systems and methods to get rid of the aforementioned systems and methods.

### OBJECT OF THE DISCLOSURE

One object of the present disclosure is to disclose an adaptive cruise speed control assistant system which automatically/manually enhances the range (distance to be covered) of the vehicle based on speed v/s mileage characteristics of the vehicle which further depends on number of passengers, load on the vehicle, tyre pressure, air conditioning load, use of vehicle.

Another object of the present disclosure is to disclose an adaptive cruise speed control assistant system which automatically/manually enhances the range (distance to be covered) of the vehicle to reach a particular destination without running out of fuel in geographical area having less or no fuel/charging stations.

Another object of the present disclosure is to disclose an adaptive cruise speed control assistant system which automatically/manually enhances the range (distance to be covered) of the vehicle to reach nearest fuel/charging station under low fuel/charging warning.

Another object of the present disclosure is to disclose an adaptive cruise speed control assistant system which automatically/manually enhances the Mileage of the vehicle to reduce running cost per km of the vehicle.

Another object of the present disclosure is to disclose an adaptive cruise speed control assistant system which automatically/manually enhances the range (distance to be covered) of the vehicle to reduce running cost per km of the vehicle.

Another object of the present disclosure is to disclose an adaptive cruise speed control assistant system which automatically/manually reduces consumption of fuel volume/km to reduce vehicular pollution.

Another object of the present disclosure is to disclose an adaptive cruise speed control assistant system which automatically/manually enhances the range (distance to be covered) of the vehicle and refills the fuel/charge at reduced cost in different geographical area or place where cheap fuel/recharge is available.

Another object of the present disclosure is to disclose an adaptive cruise speed control assistant system which automatically informs, vehicles and assists the user to use the vehicle at optimum speed to reduce fuel cost/km, reduce pollution, to refill/charge vehicle as per geographical constraints forecast.

Another object of the present disclosure is to disclose an adaptive cruise speed control assistant system which automatically/manually selects environment friendly route out of 2 or 3 or more alternative routes connecting two or more geographical areas.

Another object of the present disclosure is to disclose an adaptive cruise speed control assistant system which automatically/manually enables reaching just in/out time in a geographical area with restricted time entries while optimising fuel cost and time as per the need of the user and compliance of local traffic & other rules of geographical area (country/state/city/municipal limits).

Another object of the present disclosure is to disclose an adaptive cruise speed control assistant system which automatically/manually enables reaching just in/out time in a charging station to optimise waiting period or optimise charging cost wherever charging cost varies with Time of the Day (TOD) or parking cost is variable or reduce pollution or reduce traffic or reduce number of accidents.

Another object of the present disclosure is to disclose an adaptive cruise speed control assistant system which automatically/manually enables reaching just in/out time in a fuel station to optimise waiting period or optimise charging cost wherever charging cost varies with Time of the Day (TOD) or parking cost is variable or reduce pollution or reduce traffic or reduce number of accidents.

Another object of the present disclosure is to disclose an adaptive cruise speed control assistant system which automatically/manually enables reaching just in/out time in a CNG station to optimise waiting period or optimise charging cost wherever charging cost varies with Time of the Day (TOD) or parking cost is variable or reduce pollution or reduce traffic or reduce number of accidents.

Another object of the present disclosure is to disclose an adaptive cruise speed control assistant system which automatically/manually enables coordination between two or more vehicles and control room thereof to optimise waiting period or optimise charging cost wherever charging cost varies with Time of the Day (TOD) or parking cost is variable or reduce pollution or reduce traffic or reduce number of accidents.

Another object of the present disclosure is to disclose an adaptive cruise speed control assistant system which can be implemented to avoid traffic congestion in air space near airport, reduce load on Air Traffic control system, avoid mid-air collision and reduce pollution near airports.

Another object of the present disclosure is to disclose an adaptive cruise speed control assistant system which can be implemented to trains approaching a railway station, buses approaching a bus stand, ships approaching a sea port, and so on.

Another object of the present disclosure is to disclose an adaptive cruise speed control assistant system which enables modification of the adaptive cruise speed automatically/manually depending upon one or more goals in terms of Range (in Km), Mileage (Km/litre), Fuel cost/km (INR/litre), Fuel volume/km, Travel distance & time restrictions compliance in different geographical areas.

Another object of the present disclosure is to disclose the aforementioned adaptive cruise speed control assistant systems to existing vehicles or new vehicles.

Another object of the present disclosure is to disclose various methods for working of the aforementioned adaptive cruise speed control assistant systems.

### SUMMARY OF THE DISCLOSURE

In an aspect of the present disclosure, an adaptive cruise speed control assistant system (100) for vehicle(s) is disclosed. The system (100) includes an input device (102) to receive input comprising starting and end points of the route, vehicular information, route information, and instructions to follow adaptive cruise speed or override the adaptive cruise speed; a battery (106) integrated with a battery information unit; a fuel tank (108) equipped with a fuel meter; a speed monitor (110); an odometer (112); a plurality of sensors (114), a passenger counter (116); an air conditioning status monitor (118); a Personal Digital Assistant (PDA) (122); a cruise speed control setup (104). The system (100) also includes a microcomputer (152) having a microprocessor integrated with a plurality of modules; a GPS cloud server (126). The system (100) adapts to set the cruise speed basis speed versus goals comprising range, mileage, fuel running and refuel cost per km, fuel or charge refill, price, fuel volume per km, and travel distance and time restrictions compliance in different geographical areas depending upon number of factors comprising Passenger Factor (PF), Tyre Pressure factor (TPF), Use Factor (UF), Air Conditioning Factor (ACF), and Load Factor (LF) to obtain Net Factor (NF) as per vehicle make and model.

In an embodiment, the input device (102) is a display with keypad to receive manual input from a user.

In an embodiment, the user inputs starting and end points of the route manually.

In an embodiment, the input device (102) is a vehicular information unit (128) includes a connected area network (CAN) (206) to obtain vehicular information automatically.

In an embodiment, the vehicular information includes battery status, fuel status, LF, PF, TPF, UF, ACF, and Net Factor (NF).

In an embodiment, the route information comprising route type, specific route, alternate routes, a particular nearest functional fuel or charging station along with fuel or charge price in a given geographical area from respective sources, meeting hours, meeting IN and OUT timing schedule, time restrictions, route restrictions, and, if any jam due to a plurality of factors comprising traffic, people, event occurrence, natural calamities, accidents, road construction in all possible routes from the starting point until the end point.

In an embodiment, the fuel price for the specific route or alternate routes is the latest price as per the sources and vehicle make and model.

In an embodiment, the input device (102) fetches the route information via the GPS cloud server (126).

In an embodiment, the starting and end points of the route are in different geographical areas having different set of conditions comprising speed limits, road conditions, Time of the Day (TOD) charging tariff, fuel price, traffic laws, weather conditions, events occurrence, and traffic flow timing restrictions, and traffic conditions deciding average speed.

In an embodiment, the geographical area includes interstate, intrastate, inter countries.

In an embodiment, vehicle(s) comprising fuel vehicles, hybrid vehicles, electric vehicles running on land, water, in air and space.

In an embodiment, the vehicle(s) is a single vehicle onboard by the user.

In an embodiment, the vehicle(s) comprising two or more vehicles in communication with each other through the GPS cloud server (126) and to meet at a common point, each of the two or more vehicles travel same distance to reach the common point.

In an embodiment, the vehicle(s) comprising two or more vehicles in communication with each other and meet at a common point, each of the two or more vehicles travel different distances to reach the common point or reach or depart from two or more stations.

In an embodiment, the vehicle(s) comprising two or more vehicles in communication with each other and to depart from a common point, each of the two or more vehicles travel same distance to reach the common point.

In an embodiment, the vehicle(s) comprising two or more vehicles in communication with each other and to depart from a common point, each of the two or more vehicles travel different distances to reach the common point.

In an embodiment, the vehicle(s) comprising two or more vehicles in communication with each other where one or more vehicles thereof reach at “one” point and remaining vehicles thereof depart from a point different from the “one” point, each of the two or more vehicles travel same distance to reach respective one or multiple such points.

In an embodiment, the vehicle(s) comprising two or more vehicles in communication with each other where one or more vehicles thereof reach at “one” point and remaining vehicles thereof depart from a point different from the “one” point, each of the two or more vehicles travel different distance to reach respective one or multiple such points.

In an embodiment, the journey comprising up, down, and round.

In an embodiment, the load comprising goods, vehicles, and passengers.

In an embodiment, the fuel goal is basis the fuel availability in the fuel tank or the charge availability in the battery in alone or in combinations thereof; presence of functional fuel stations in direct or alternative routes between the starting point and the end point.

In an embodiment, the range goal is such that the vehicle has to complete journey without running out of fuel or charge in alone or in combination thereof or maximize distance to be covered with given fuel available in the fuel tank or given charge available in the charged battery.

In an embodiment, the range goal is such that the vehicle reaches nearest fuel or charging station under low fuel or charging warning.

In an embodiment, setting of the ‘new adaptive cruise speed’ also depends upon selection of environment friendly route out of two or three or more alternative routes connecting more than one geographical area.

In an embodiment, ‘new adaptive cruise speed’ is such that the vehicle reaches just in or out time in a geographical area with restricted time entries while optimising fuel cost and time as per the need of the user and compliance of local traffic and rules of the geographical area.

In an embodiment, the ‘new adaptive cruise speed’ is such that the vehicle completes the journey with optimisation of time or fuel cost.

In an embodiment, the system (100) includes preference for minimum charging or fuel refilling cost from varied fuel or charging prices in different geographical areas.

In an embodiment, the ‘new adaptive cruise speed’ is such that the vehicle reaches just in or out time in a fuel station or charging station or CNG station to optimise waiting period or optimise fuel or charging cost wherever fuel or charging cost varies with Time of the Day (TOD) or variable parking cost or reduce pollution or reduce traffic or reduce number of accidents or combination thereof.

In an embodiment, the system (100) comprising coordination between two or more vehicles and a control room thereof to optimise waiting period or optimise fuel or charging cost wherever fuel or charging cost varies with Time of the Day (TOD) or variable parking cost or reduce pollution or reduce traffic or reduce number of accidents or combination thereof.

In an embodiment, the ‘new adaptive cruise speed’ is set so as to avoid traffic congestion in air space near airport, reduce load on Air Traffic control system, avoid mid-air collision and reduce pollution near airports, bus stands, shipping ports and other vehicles meeting points.

In an embodiment, the system (100) is installable in existing vehicles.

In an embodiment, the fuel comprising CNG, petrol, diesel, hydrogen, biodiesel, ethanol, propane, and hydrogen.

In an embodiment, the system (100) automatically informs, trains and assists the user to use the vehicle.

In an embodiment, the system (100) assists in optimizing speed to reduce running cost per km of the vehicle.

In an embodiment, the system (100) assists in optimizing range of the vehicle in order to refill the fuel or charge at reduced cost in different geographical area or place where cheap fuel or recharge is available.

In an embodiment, the charge comprising electric charge or solar charge.

In another aspect of the present disclosure, a method (1000) for setting up “new adaptive cruise speed” of a vehicle(s) equipped with the system (100) is disclosed. The method (1000) involves receiving input comprising starting and end points of the route, followed by receiving vehicular information, receiving route information and processing thereto. The method (1000) further involves processing the input, the vehicular information, and the route information, followed by determining GPS coordinates of the vehicle with respect to the route to be followed by the vehicle, other vehicles and other point of interest enroute or otherwise. Then, the method (1000) is configured to analyse the processed input to take a decision if to set up ‘new adaptive cruise speed’ or override the ‘new adaptive cruise speed’, followed by setting the ‘new adaptive cruise speed’ automatically or as per the instructions provided by the user to override the ‘new adaptive cruise speed’ and actuating fuel supply or current supply in the vehicle in conformation with the decision. Then, the method (1000) involves controlling speed of wheels of the vehicle in conformation with the decision, followed by displaying the query for the user if to follow the ‘new adaptive cruise speed’ or override the ‘new adaptive cruise speed’, followed by displaying the selected speed accordingly.

In another aspect of the disclosure, a non-transitory computer-readable medium storing instructions which, when executed by one or more processors of an adaptive cruise speed control assistant system (100) is disclosed. The system (100) causes the processor(s) to receive input comprising starting and end points of a route, vehicular information, and route information; analyze vehicle parameters including speed, mileage, battery status from a battery information unit (106A), fuel status from a fuel tank (108), Passenger Factor (PF) from a passenger counter (116), Tyre Pressure Factor (TPF) from a tyre pressure monitoring sensor, Use Factor (UF) from an odometer (112), Air Conditioning Factor (ACF) from an air conditioning status monitor (118), Load Factor (LF) from a load sensor, and Net Factor (NF); determine a new adaptive cruise speed based on range, fuel or charge availability, route restrictions, cost optimization, and time-of-day conditions; actuate a controller (208) having an actuator (210) to adjust fuel or current supply to conform with the determined adaptive cruise speed; and communicate the adaptive cruise speed and control status to a display (122) or a connected Personal Digital Assistant (PDA) (122) for confirmation or override by the user. The new adaptive cruise speed is adapted dynamically based on speed versus goals comprising range, mileage, refuel or recharge cost per kilometer, and travel distance or time compliance in different geographical areas depending upon the average of Passenger Factor (PF), Tyre Pressure Factor (TPF), Use Factor (UF), Air Conditioning Factor (ACF), Load Factor (LF), and Net Factor (NF) as per vehicle make and model.

In another embodiment, the computer-readable medium involves determining the new adaptive cruise speed comprises comparing stored speed-versus-mileage characteristics from a vehicle information module (152G) with live sensor data received from the vehicular information unit (128). The processor(s) further transmits adaptive cruise data to a GPS cloud server (126) for logging or fleet analytics.

In another aspect of the disclosure, a vehicle includes a propulsion system; a plurality of sensors including a battery information unit (106A), a fuel meter associated with a fuel tank (108), a tyre pressure monitoring sensor, a passenger counter (116), and a load sensor; a control unit in communication with the sensors; and an adaptive cruise speed control assistant system (100) configured to receive route and vehicular information via an input device (102); analyze the vehicular parameters to determine a new adaptive cruise speed based on a Net Factor (NF) derived from Passenger Factor (PF), Tyre Pressure Factor (TPF), Use Factor (UF), Air Conditioning Factor (ACF), and Load Factor (LF); and control the propulsion system of the vehicle by actuating a controller (208) having an actuator (210) in conformation with the determined adaptive cruise speed. The adaptive cruise speed control assistant system (100) adapts to maintain an optimized speed profile to complete the journey with compliance to travel time restrictions, minimum fuel or charge cost, and mileage optimization under varying geographical conditions using data from a GPS cloud server (126).

In another embodiment, the adaptive cruise speed control assistant system (100) further selects an environmentally friendly route among multiple alternatives to minimize fuel or charging cost and travel time using data from a GPS cloud server (126).

In another embodiment, the vehicle may be an electric, hybrid, or hydrogen-powered vehicle, and the adaptive cruise speed control assistant system (100) coordinates fuel or charge refilling based on cost and station availability along the route.

In another aspect of the present disclosure, a system for coordinated adaptive cruise control among multiple vehicles is disclosed. The system includes a plurality of adaptive cruise speed control assistant systems, each installed in a respective vehicle and configured to communicate via a shared GPS cloud server (126).

In an embodiment, each system (100) exchanges position, speed, and route data with other vehicles to synchronize adaptive cruise speeds such that meeting or departure points are optimized for time, fuel or charge cost, and traffic-law compliance across the fleet.

In an embodiment, the synchronization further adapts to ensure that vehicles reach refueling or charging points at just-in or just-out times, minimize idle durations, balance route density, and collectively reduce emissions or congestion within the coordinated geographical area.

In an embodiment, synchronization includes adjusting speed such that two or more vehicles reach a common refueling or charging station at just-in or just-out time to minimize waiting or cost, and coordinates through respective controllers (208) in each vehicle.

In an embodiment, the shared GPS cloud server (126) further provides aggregated analytics on mileage efficiency, congestion reduction, and emissions optimization across the coordinated vehicles.

### BRIEF DESCRIPTION OF THE DRAWINGS

Other objects, features, and advantages of the embodiment will be apparent from the following description when read with reference to the accompanying drawings. In the drawings, wherein like reference numerals denote corresponding parts throughout the several views:

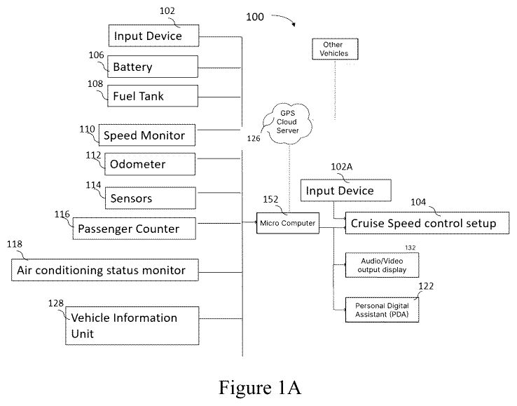

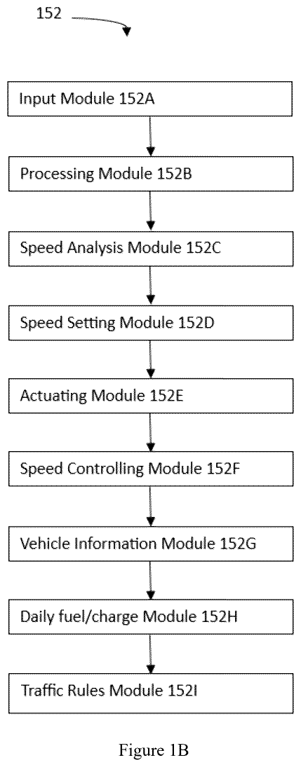

Referring to FIG. 1A, a block representation of an adaptive speed cruise control assistant system (100) is shown, in accordance with an illustrative embodiment of the present disclosure;

Referring to FIG. 1B, a block representation of various components of a microcomputer (152), in accordance with the illustrative embodiment of the present disclosure;

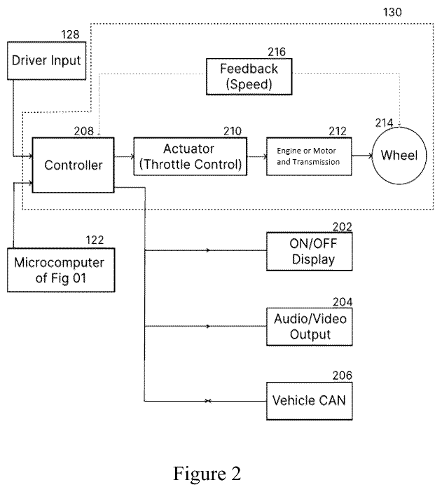

Referring to FIG. 2, a block representation of integration of the adaptive speed cruise control assistant system (100) with existing cruise control is shown, in accordance with another illustrative embodiment of the present disclosure;

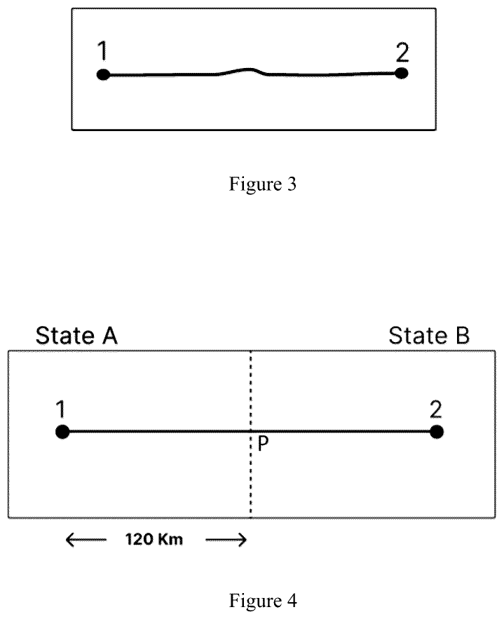

Referring to FIG. 3, show Start and End points for the journey, in accordance with another illustrative embodiment of the present disclosure;

Referring to FIG. 4, show Start and End points for the journey through two geographical areas, in accordance with another illustrative embodiment of the present disclosure;

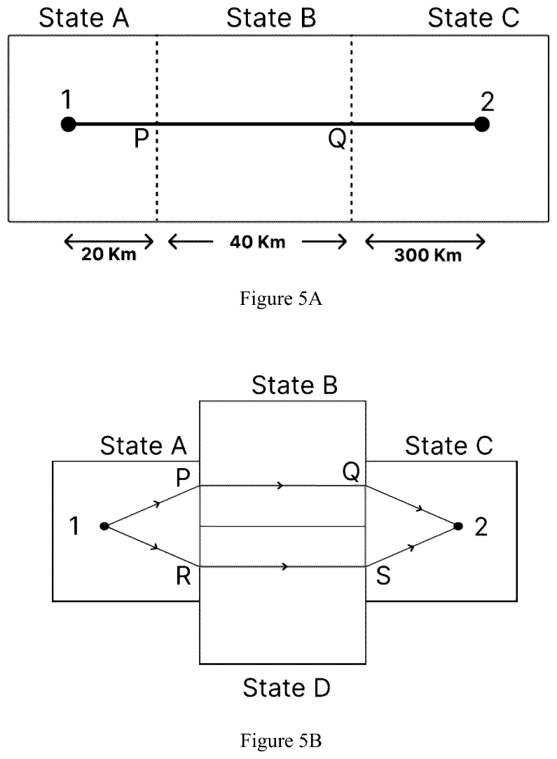

Referring to FIGS. 5A and 5B, FIG. 5A shows Start and End points for the journey through three geographical areas while FIG. 5B shows Start and End point diagram for the journey through four geographical areas with alternate route available through different geographical areas, in accordance with another illustrative embodiment of the present disclosure;

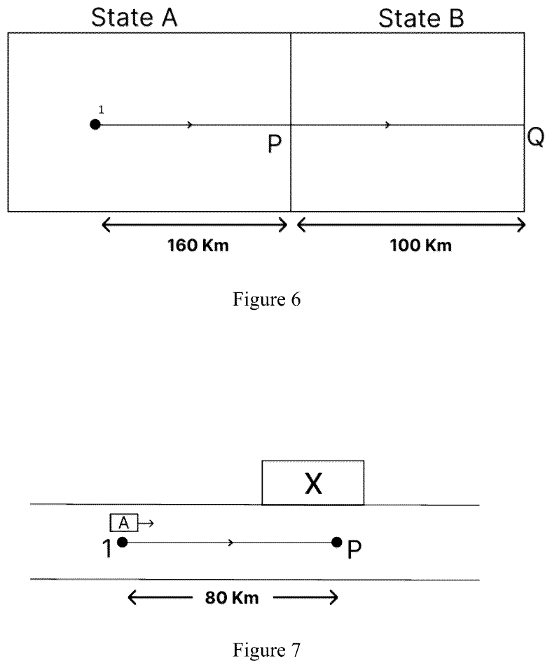

Referring to FIG. 6, shows “Just in Time” and “Just out Time” diagram in a geographical area with time restrictions, in accordance with another illustrative embodiment of the present disclosure;

Referring to FIG. 7, shows “Just in Time” to reach an exemplary charging station, in accordance with another illustrative embodiment of the present disclosure;

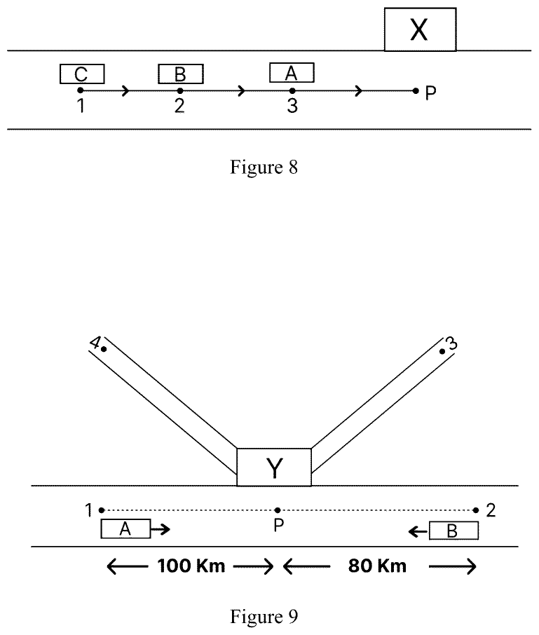

Referring to FIG. 8, shows two or more exemplary vehicles approaching a station X, in accordance with another illustrative embodiment of the present disclosure;

Referring to FIG. 9, shows two or more exemplary vehicles approaching station Y from different directions, in accordance with another illustrative embodiment of the present disclosure; and

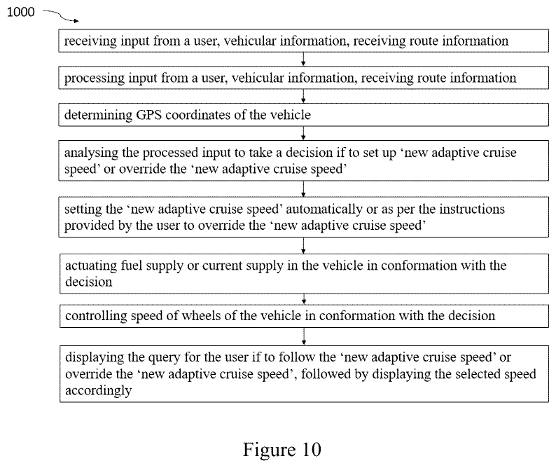

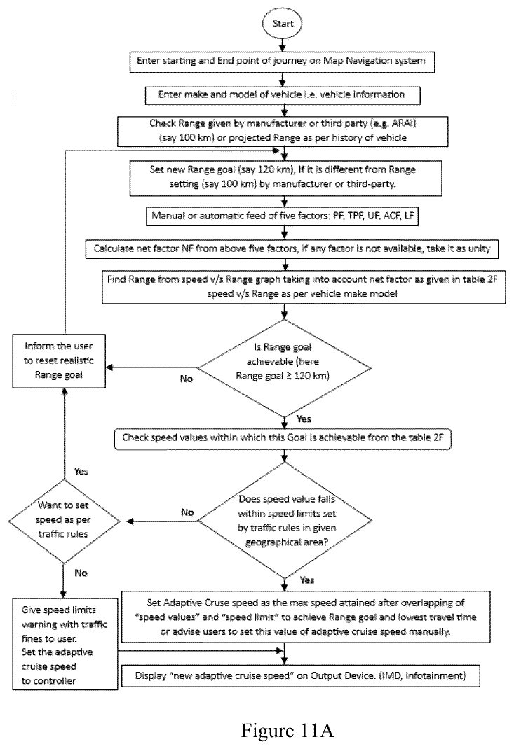

Referring to FIG. 10, shows a flowchart depicting steps of a method (1000) for setting up “new adaptive cruise speed” of the vehicle(s) equipped with the adaptive cruise speed control assistant system (100), in accordance with another illustrative embodiment of the present disclosure.

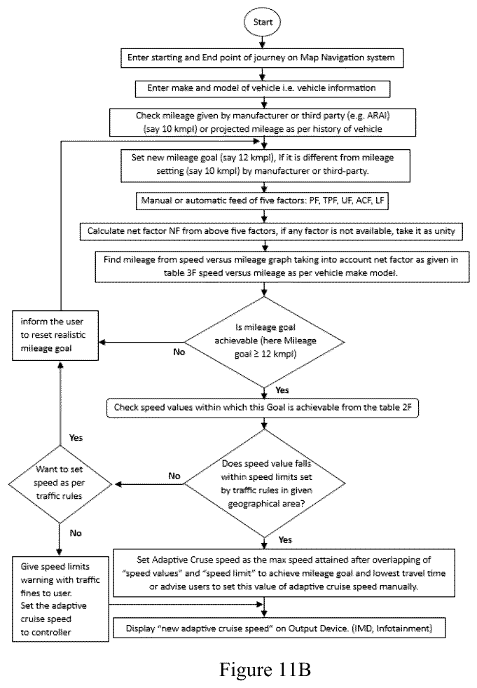

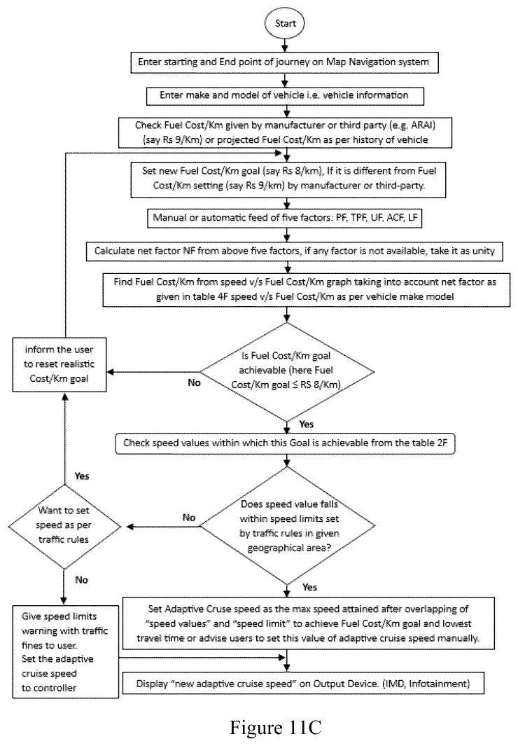

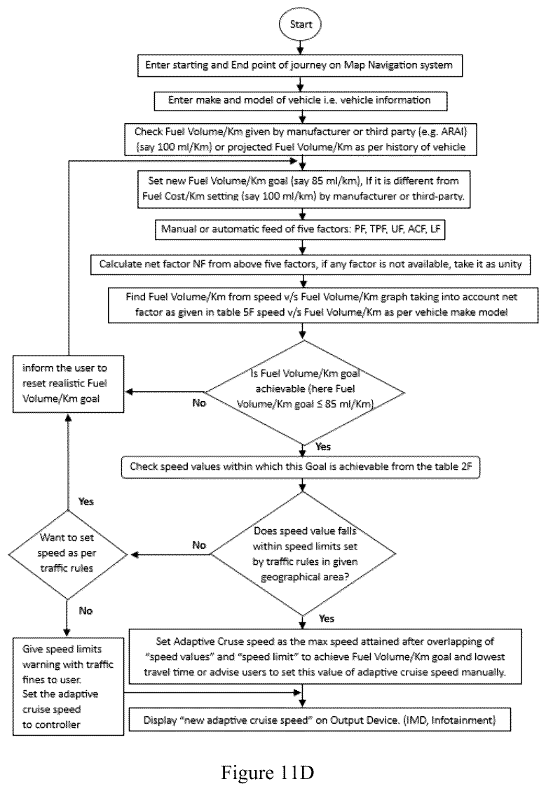

Referring to FIG. 11A, shows a flowchart depicting steps of a method to achieve Range Goal, in accordance with another illustrative embodiment of the present disclosure.

Referring to FIG. 11B, shows a flowchart depicting steps of a method to achieve Mileage Goal, in accordance with another illustrative embodiment of the present disclosure.

Referring to FIG. 11C, shows a flowchart depicting steps of a method to achieve Fuel Cost/km Goal, in accordance with another illustrative embodiment of the present disclosure.

Referring to FIG. 11D, shows a flowchart depicting steps of a method to achieve Fuel volume/km Goal), in accordance with another illustrative embodiment of the present disclosure.

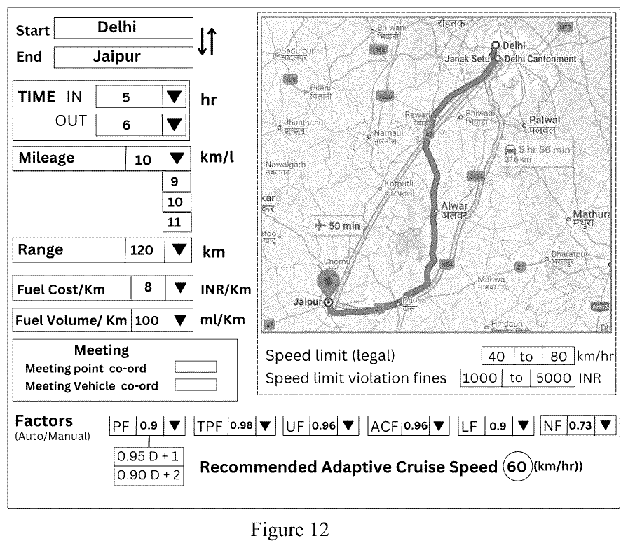

Referring to FIG. 12, shows an exemplary presentation of the system (100) on Personal Digital Assistant in a vehicle e.g., Multi Information Display, Infotainment system, a mobile phone etc., in accordance with the illustrative embodiment of the present disclosure.

### DETAILED DESCRIPTION OF THE PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The term “vehicle” herein refers to all existing vehicles including such as but not limited to light, heavy, electric, non-electric, bicycle, tricycle, scooter, bike, autorickshaws, bus, cars, trucks, aeroplanes, jet air crafts, armoured vehicles, vehicles carrying goods or crane, All Terrain vehicles, trains, ships, and so on. The vehicle may refer to fuel vehicles, hybrid vehicles, electric vehicles running on land, water, in air and space. The vehicle may also refer to a single vehicle onboard by the user. The vehicle(s) or vehicles may also refer to two or more vehicles in communication with each other. Such vehicle(s) or vehicles may either about to meet at a common point of meeting.

As shown in FIG. 1, an adaptive speed cruise control assistant system (100) for vehicles (not shown) is disclosed. The system (100) includes an input device (102), a cruise control setup (104), a battery (106), a fuel tank (108), a speed monitor (110), an odometer (112), a plurality of sensors (114), a passenger counter (116), an air conditioning status monitor (118), a Personal Digital Assistant (PDA) (122), a display (122), a GPS cloud server (126), and a vehicle information unit (128).

The input device (102) is configured to receive input from a user manually or automatically through a number of components or sensors as described hereinafter. The input may include such as but not limited to starting and end points of the route, vehicular information, route information, and instructions to follow adaptive cruise speed or override the adaptive cruise speed. In an embodiment, the input device (102) is a display (122) with keypad to receive manual input from a user. The user inputs starting and end points of the route manually which is visible on the display (122). The starting and end points of the route may be in different geographical areas having different set of conditions. Such conditions may include such as but not limited to speed limits, road conditions, Time of the Day (TOD) charging tariff, fuel price, traffic laws, weather conditions, events occurrence, and traffic flow timing restrictions, and traffic conditions deciding average speed. The geographical area may include such as but not limited to interstate, intrastate, inter countries. All conditions mentioned enroute can be filled automatically or manually.

In alternative embodiments, the input device (102) is a vehicular information unit (128) having a connected area network (CAN) (206) to obtain vehicular information automatically. The vehicular information may include such as but not limited to battery status, fuel status, Passenger Factor (PF), Tyre Pressure factor (TPF), Use Factor (UF), Air Conditioning Factor (ACF), and Load Factor (LF). The vehicular information may also include multiplication of all the factors including such as but not limited to LF, PF, TPF, UF, ACF to obtain Net Factor (NF).

The route information includes such as but not limited to route type, specific route, alternate routes, a particular nearest functional fuel or charging station along with fuel or charge price in a given geographical area from respective sources, meeting hours, meeting IN and OUT timing schedule, time restrictions, route restrictions, and, if any jam due to a plurality of factors comprising traffic, people, event occurrence, natural calamities, accidents, road construction in all possible routes from the starting point until the end point. The fuel price or cost for the specific route or alternate routes is the latest cost as per the sources and vehicle make and model. It can be fetched automatically from cloud server or fed manually by user.

The battery (106) is integrated with a battery information unit. The battery information unit is configured to determine capacity of the battery (106) and charging status thereof. The fuel tank (108) is equipped with a fuel meter to determine volume of fuel and dynamic fuel level volume in the fuel tank (108).

The speed monitor (110) is configured to measure and monitor cruise speed of the vehicle.

The odometer (112) is configured to determine total distance covered by the vehicle “till date” to determine Use factor (UF);

The sensors (114) include such as but not limited to load sensor to monitor load status, tyre pressure monitoring sensor to determine Tyre Pressure factor (TPF), anti-lock brake system (ABS) speed sensors (114C), and a fuel volume sensor.

The passenger counter (116) is configured to count number of passengers sitting in the vehicle to determine Passenger Factor (PF).

The air conditioning status monitor (118) is configured to monitor heating and cooling status along with air conditioning power load to determine Air conditioning factor (ACF).

The Personal Digital Assistant (PDA) (122) is configured to communicate with the vehicle, a server, and other vehicles in communication with the vehicle.

The system (100) also includes Audio/Video display (132) (displaying the user about cruise speed and other related information/instruction/warning/advisory, and so on) and the Personal Digital Assistant (PDA) (122).

The cruise speed control setup (104) is in communication with the system (100). The system (100) is configured to assist the cruise speed control setup (104).

The system (100) may be implemented to a plurality of vehicles. All such vehicles may communicate with each other through communication modules including such as but not limited to GPS cloud server (126) or GSM terminals. The GPS cloud server (126) is well known for determining GPS coordinates of the vehicle with respect to the route to be followed by the vehicle.

The system (100) is configured to require at least position coordinates of the vehicle or the vehicle(s) communicating with the vehicle. The system (100) may work in offline mode as well as online mode. The position coordinates may be input manually and determined through well-known methods in the art.

As shown in FIG. 1B, the microcomputer or microcontroller (152) is associated with a plurality of modules to fetch information from various aforementioned components of the system (100), that further integrates with cruise speed control setup (104). The microcontroller (152) further gives instructions to the cruise speed control setup (104) to modify or change speed. The cruise speed control setup (104) also receives driver input to have manual override or manual control over speed.

The input module (152A) to receive the input either from the user manually or from the vehicular information unit (128).

The processing module (152B) is configured to process the input received from the input module (152A). Inputs are e.g., Passenger factor and Tyre pressure factor etc. All factors are multiplied to get Net factor. Net factor is used to find corresponding adaptive cruise speed with a given goal from various tables as hereinabove.

The speed analysis module (152C) is configured to analyse the processed input to take a decision if to set up ‘new adaptive cruise speed’ or override the ‘new adaptive cruise speed’.

The speed setting module (152D) is configured to set the ‘new adaptive cruise speed’ automatically or as per the instructions provided by the user to override the ‘new adaptive cruise speed’. The speed setting module (152D) adapts to set the cruise speed basis speed versus goals comprising range, mileage, fuel running and refuel cost per km, fuel or charge refill, price, fuel volume per km, and travel distance and time restrictions compliance in different geographical areas depending upon number of factors comprising Passenger Factor (PF), Tyre Pressure factor (TPF), Use Factor (UF), Air Conditioning Factor (ACF), and Load Factor (LF) to obtain Net Factor (NF) as per vehicle make and model.

The actuating module (152E) is configured to actuate fuel supply or charge supply in the vehicle through the controller (208). The controller (208) includes an actuator (210). The actuator (210) is configured to actuate the fuel or charge supply in conformation with the decision taken by the speed analysis module (152C).

The speed controlling module (152F) is configured to control speed of wheels of the vehicle. Such speed is dependent upon the decision taken by the speed analysis module (152C);

The vehicle information module (152G) has vehicle make, model, and speed versus mileage characteristics of the vehicle as per make and model. Such characteristics are stored under standard conditions stored in either memory of the microcomputer (152) or on GPS or cloud server (126). The standard conditions vary from country to country. Vehicle information data mentioned can be fed by the user manually. It can be taken from vehicle CAN (206) as per use history (e.g., mileage) of vehicle.

The daily fuel or charge price module (152H) is configured to have fuel or charge price information. Such information is updated daily in either memory of the microcomputer (152) or on GPS cloud server (126). The display (122) is configured to display the query for the user if to follow the ‘new adaptive cruise speed’ or override the ‘new adaptive cruise speed’ and then displays the selected speed accordingly. Fuel price information can be fetched automatically from cloud server or fed by user manually.

Traffic Rules module (152I) is configured to have speed limits, traffic rules violation penalties, parking charges, TIME IN and TIME OUT permissions in given geographical area.

Speed vs mileage table may be drawn by running the vehicle with constant speed and measuring the distance when fuel consumed is one litre. Such a process of measuring is mentioned in Bureau of Indian standard BIS 11921. Other examples of such tests of the above process of measuring may include such as but not limited to other Constant Speed Fuel Consumption Test (CSFC) and similar test available in different countries having different standards. Using speed vs mileage relation, other parameters including such as but not limited to Range, Fuel Cost/distance, Fuel Volume/distance may also be calculated.

One example for a given vehicle is given in table below and may be used throughout the description herein.

TABLE 1

| | | | | | | | | | |
|---|---|---|---|---|---|---|---|---|---|
| Speed (km/hr) | 30 | 40 | 50 | 60 | 70 | 80 | 90 | 100 | 110 |
| Mileage (km/litre) | 14 | 16 | 17 | 16 | 14 | 12 | 10 | 9 | 7 |
| Range (km) | 140 | 160 | 170 | 160 | 140 | 120 | 100 | 90 | 70 |
| Fuel cost/ | 6.4 | 5.6 | 5.3 | 5.6 | 6.4 | 7.5 | 9 | 10 | 12.9 |
| distance (INR/km) | | | | | | | | | |
| Fuel | 71.4 | 62.5 | 58.8 | 62.5 | 71.4 | 83.3 | 100 | 111 | 143 |
| Volume/distance | | | | | | | | | |
| (millilitre/km) | | | | | | | | | |

(Assumption: Fuel in tank = 10 litre, Fuel price = 90 INR/litre, Net Factor NF = 1)

### Equivalent Table for Electric Vehicle

| | | | | | | | | |
|---|---|---|---|---|---|---|---|---|
| Speed (km/hr) | 30 | 40 | 50 | 60 | 70 | 80 | 90 | 100 |
| Mileage (km/kwh) | 8.33 | 7.41 | 6.67 | 6.67 | 6.67 | 5.56 | 4.76 | 4.17 |
| Range (km) | 250 | 222 | 200 | 200 | 200 | 167 | 143 | 125 |
| Electric cost/ | 0.96 | 1.08 | 1.20 | 1.20 | 1.20 | 1.44 | 1.68 | 1.92 |
| distance (INR/km) | | | | | | | | |
| Electric | 120 | 135 | 150 | 150 | 150 | 180 | 210 | 240 |
| Energy/distance | | | | | | | | |
| (wh/km) | | | | | | | | |

(Assumption: Battery capacity is 30 Kwh for Range Calculation Purpose)

1. Mileage Variations with Various Factors

Mileage (distance covered per unit volume or charge) depends on speed, number of passengers sitting, goods load, tyre pressure, Air Conditioning, use of vehicle till date etc. when vehicle is in running condition. Various factors used to quantify including such as but not limited to passenger load, Tyre pressure, Air conditioning, Use of vehicle, goods load with respect to given vehicle.

Various Factors to be used in description are defined herein below. Such factor tables numerical values are given as exemplary only to be contemplated for the skilled persons in the art to understand the present disclosure. True value of such factors may be provided by vehicle manufacturer or testing bodies like ARAI or user may experiment and make these tables as per experience.

1.1. Passenger Factor (PF)=Effective Mileage with Certain Passengers/Actual Mileage with Driver Only

### Passenger Factor (PF) Table 1A:

| Passengers | Driver only | Driver + 1 | Driver + 2 | Driver + 3 | Driver + 4 |
|---|---|---|---|---|---|
| PF | 1.0 | 0.95 | 0.90 | 0.85 | 0.80 |

Number of passengers in a vehicle may be determined from a number of following exemplary methods including such as but not limited to:
a) No. of seat belts in “ON” state
Example: In 7-seater vehicle, if 3 seat belts are “ON” means 3 persons are sitting in the vehicle. 4 seats are in “OFF” state means that there are no persons sitting in the remaining 4 seats.]
b) Load cells under seats may detect whether a person is in seat or it is vacant.
c) Axle load may be used to check vehicle load status
d) Manual counting by driver/user

As number of passengers increase, fuel efficiency i.e. mileage (km/litre) decreases as given in Table 1A above.

1.2. Tyre Pressure Factor (TPF)=Effective Mileage with Certain Tyre Pressure/Actual Mileage with Recommended Tyre Pressure.

### Tyre Pressure Factor (TPF) in Below Table 1B:

| | Tyre pressure as % age of | | | | | |
|---|---|---|---|---|---|---|
| | recommended tyre pressure value | | | | | |
| | 100% | 90% | 80% | 70% | 60% | 50% |
| Tyre Pressure Factor TPF | 1.00 | 0.98 | 0.96 | 0.94 | 0.92 | 0.90 |

Tyre pressure is available on vehicle CAN (Connected Area Network) through tyre pressure monitoring system (TPMS) or can be fed manually by the user.
As tyre pressure decreases, TPF decreases. Tyre Pressure data is taken from TPMS (114) and fed to microcomputer (152) for calculating the TPF or user feeds it manually.
1.3. Use Factor (UF)=Effective Mileage with Used or Old Vehicle/Actual Mileage with New Vehicle.

### Use Factor (UF) Table as Shown in Below Table 1C

| | Odometer reading (Km) | | | | | |
|---|---|---|---|---|---|---|
| | 0 | 50000 | 100000 | 150000 | 200000 | 250000 |
| Use Factor UF | 1.00 | 0.96 | 0.92 | 0.88 | 0.84 | 0.80 |

As distance covered by the vehicle increases with use, UF decreases. Use of vehicle data is taken from odometer (112) and fed to microcomputer (152) for calculating Use Factor (UF). OR user feeds it manually.
1.4. Air Conditioning Factor (ACF)=Effective Mileage with Certain Air Conditioner Setting/Actual Mileage with Zero or No Air Conditioning.

### Air Conditioning Factor (ACF) Table in Table 1D

| | Air conditioning levels (% age of max) | | | | | |
|---|---|---|---|---|---|---|
| | AC | Level1 | Level2 | Level3 | Level4 | Level5 |
| | OFF | (20%) | (40%) | (60%) | (80%) | (100%) |
| AC Factor (ACF) | 1.0 | 0.98 | 0.97 | 0.96 | 0.95 | 0.94 |

As air conditioning level in vehicle increases, the ACF decreases. Air conditioning data is taken from the Air conditioning status monitor (118) or CAN or current supply of an Air conditioner is used and fed to microcomputer (152) for calculating the ACF or the user feeds thereto manually.
1.5 Load Factor (LF)=Effective Mileage with Certain Tyre Pressure/Actual Mileage with Recommended Tyre Pressure.

### Load Factor (LF) Table as Shown Below in Table 1E

| Load % age | 0% | 25% | 50% | 75% | 100% |
|---|---|---|---|---|---|
| Load Factor LF | 1.0 | 0.9 | 0.8 | 0.7 | 0.6 |

Load is sensed through load sensors in vehicle and Load data is available on vehicle CAN (Connected Area Network) or can be fed manually by the user.

As load increases, LF decreases. Load data is taken from load sensors and fed to microcomputer (152) for calculating LF or the user feeds thereto manually.

### 1.6 Net Factor (NF)=PF×TPF×UF×ACF×LF

Net Factor (NF) is product of all the factors as disclosed aforementioned. After all the above factors are available, the microcomputer (152) calculates NF by multiplying all the five factors discussed above and is explained below through an example.
Example 1: NF=PF×TPF×UF×ACF×LF=1×1×1×1×1=1 under ideal cases
Example 2: NF=PF×TPF×UF×ACF×LF=0.9×0.98×0.96×0.96×0.9=0.73 when different factors have different values.

### 2. Range Goal

User has certain value of fuel or charge and wants to cover certain distance without running out of fuel. Range depends on the speed of vehicle. User may change range by controlling the speed of the vehicle. User may attain desired range by getting adaptive cruise speed setting automatically or manually adjusting the cruise speed.

Following steps are followed while accounting for range variation with speed only. Effect of other factors including such as but not limited to number of passengers sitting, goods load, tyre pressure, Air Conditioning, use of vehicle till date etc. accounted subsequently.

As shown in FIG. 3 (discussed hereinafter), distance between starting point 1 and end point 2 is (say) 60 km. Distance to be covered for up and down journey is 120 km.

The system (100) may set new adaptive cruise speed such that vehicle completes journey without running out of fuel/charge.
Step 1: User enters start and end points in a given geographical area (FIG. 3) through the input device (102) and connected to GPS cloud server (126) for maps and navigation. Starting point is 1 and end point is 2 in FIG. 3 of geographical area.
Step 2: The system (100) checks fuel available in fuel tank through fuel volume sensor and charge available in battery (106) for the electric vehicle. As an example, available volume is 10 litres in fuel tank (104).
Step 3: The system (100) checks availability of fuel/charging stations in routes 1 to 2 and 2 to 1. Such a step is done by map solution API. The system (100) checks if the fuel station is functional and has the capacity to supply fuel or charge the vehicle. Such a data is available through various platforms known in the art, including such as but not limited to Map Solution and available on the GPS cloud server (126).
Step 4: The system (100) checks maximum distance (range) which may be covered at cruise speed set by user or car manufacturer or fleet owner (say 90 km/hr) and corresponding mileage (say 10 km/litre) as per speed v/s mileage data (fix for a given vehicle as per B.I.S standards).

Speed v/s mileage data is available in the memory of the microcomputer (152) or available on the GPS cloud server (126) and is given hereinabove as Table 1 as an example.

Other parameters including such as but not limited to Range, cost/km and Fuel consumed/distance is also given as a function of speed.

The system (100) calculates the range, (at speed 90 km/hr, mileage is 10 km/litre).

Here the range is =10 km/litre×10 litre=100 km
Step 5: The system (100) checks the total distance to be covered from 1 to 2 and back to point 1 (say 120 km) through distance map API.
Step 6: If the value in step 5>value in step 4, then the system (100) resets the cruise speed such that the new range (maximum possible distance) is enough to complete the journey.

Here, the system (100) sets another cruise speed (say 80 km/hr) for which the mileage (12 km/litre) as per speed v/s mileage in Table 1. As per the Table 1, range is 120 km at speed 80 km/hr.

So, new cruise speed reset=80 km/hr

Hence, the system (100) is able to perform following functions:
a) Auto reset new cruise speed (say 80 km/hr) by giving a command to the cruise speed control setup (104) and informs the user about the new cruise speed. The user may manually override the new cruise speed (80 km/hr) and manually keep it to any value. (say 90 km/hr or 70 km/hr or any other value).
b) Auto suggest new cruise speed (say 80 km/hr) through audio/pop-up/animation on audio/video output display (132). The user may set or ignore it.
c) Give reasons for auto reset of cruise speed (say 80 km/hr) through audio/video display (132) or through the Personal Digital Assistant (122).
Example: “Dear user, you may run out of fuel/charge if you cruise at 90 km/hr. System is setting a new cruise speed (say 80 km/hr) to increase the mileage (from 10 km/litre to 12 km/litre) and increase the range from (100 km to 120 km) so that you can complete the journey without running out of fuel or charge. You can manually set/reset cruise speed at your own risk.”
   2.1 Range Goal with Variation in Number of Passengers i.e., Passenger Factor (PF)

As number of passengers increases, fuel consumption increases. Mileage and Range decrease.

The vehicle mileage v/s speed along with variation due to number of passengers may be given by vehicle manufacturer or third parties in Automobile research or user may find out by performing experiments on his vehicle as per Bureau of Indian Standard BIS 11921 and varying the number of passengers. Range goal with variation in passenger factor.

Let the Passenger factor (PF)=0.95 as shown below in Table 2A (PF=0.95)

| Speed (Km/hr) | 30 | 40 | 50 | 60 | 70 | 80 | 90 | 100 | 110 |
|---|---|---|---|---|---|---|---|---|---|
| Actual Range (Km) | 140 | 160 | 170 | 160 | 140 | 120 | 100 | 90 | 70 |
| Effective Range | 133 | 152 | 161.5 | 152 | 133 | 114 | 95 | 85.5 | 66.5 |
| (with PF = 0.95) | | | | | | | | | |

Effective range = Actual range × Passenger Factor (PF)

Passenger factor is decided by number of passengers as given in Table 1A. Actual Range under ideal conditions (with PF=1) is 100 Km at speed 90 Km/hr. Required Range set by user=120 Km when Passenger Factor (PF)=0.95
From the Table 1A, effective range is more than 120 Km for speed≤70. Suggested adaptive cruise speed to get above range (more than 120 km) is 70 Km/hr.
At 70 Km/hr, effective range=133 Km.
At 70 Km/hr, effective range=133 Km which is more than required range (120 km) set by the user.
2.2 Range Goal with Variation in Tyre Pressure

User has total up and down distance of 120 km (say). Either the system picks tyre pressure automatically through CAN (120) or by manual input (118) by user. Here, the tyre pressure is 90% of the specified by manufacturer.

### TPF=0.98

Required Range as calculated from map APIs=120 km
Cruise speed set by user=90 km/hr
Adaptive cruise speed setting to complete the journey, is given by the system (100) based on the following method:

TABLE 2B
(TPF = 0.98)

| Speed (Km/hr) | 30 | 40 | 50 | 60 | 70 | 80 | 90 | 100 | 110 |
|---|---|---|---|---|---|---|---|---|---|
| Range (Km) | 140 | 160 | 170 | 160 | 140 | 120 | 100 | 90 | 70 |
| Effective Range | 137.2 | 157 | 166.6 | 157 | 137.2 | 117.6 | 98 | 88.2 | 68.6 |
| (with TPF = 0.98) | | | | | | | | | |

Effective range = Actual range × Tyre Pressure Factor (TPF)

Tyre Pressure factor is decided by tyre pressure as given in Table 1B

Actual Range under ideal conditions (with TPF=1) is 100 Km at speed 90 Km/hr. Required Range set by user=120 Km when Tyre Pressure Factor (TPF)=0.95

From the Table 2B, effective range is more than 120 Km for speed≤70. Suggested adaptive cruise speed to get above range is 70 Km/hr.
At 70 Km/hr, effective range=137.2 Km which is more than required range (120 km) set by the user.
2.3 Range Goal with Variation in Use of Vehicle

User one has total up and down distance of 120 km. Either the system (100) picks odometer reading automatically through vehicle information unit (128) such as CAN or by input device (102) manually by user.

Here odometer reading is 50000 km.

### Use Factor (UF), as per the Table 1C, is UF=0.96

Required Range as calculated from map APIs=120 km
Cruise speed set by user=90 km/hr
Adaptive cruise speed setting to complete the journey, is given by the system based on the following method.

TABLE 2C
(UF = 0.96)

| | Speed (Km/hr) | | | | | | | |
|---|---|---|---|---|---|---|---|---|
| | 30 | 40 | 50 | 60 | 70 | 80 | 90 | 100 |
| Range (Km) | 140 | 160 | 170 | 160 | 140 | 120 | 100 | 90 |
| Effective | 134.4 | 153.6 | 163.2 | 153.6 | 134.4 | 115.2 | 96 | 86.4 |
| Range (with | | | | | | | | |
| UF = 0.96) | | | | | | | | |

Effective range = Actual range × Use Factor (UF)

Use Factor is decided by odometer reading as given in Table 1C
Actual Range under ideal conditions (with UF=1) is 100 Km at speed 90 Km/hr. Required Range set by user=120 Km when Use Factor (UF)=0.96
From the table 1C, effective range is more than 120 Km for speed≤70. Suggested adaptive cruise speed to get above range is 70 Km/hr.
At 70 Km/hr, effective range=134.4 Km which is more than required range (120 km) set by the user.
2.4 Range Goal with Variation in Air Conditioning
User has total up and down distance of 120 km. Either the system (100) picks air conditioning value automatically (say through CAN) or by manual feed by driver. Here air conditioning level is 3 i.e. 60% of FULL AC (say).

### ACF is 0.96 as per Table 1D.

Required Range as calculated from map APIs=120 km
Cruise speed set by user=90 km/hr
Adaptive cruise speed setting to complete the journey, is given by the system based on the following method.

TABLE 2D
(ACF = 0.96)

| | Speed (Km/hr) | | | | | | | |
|---|---|---|---|---|---|---|---|---|
| | 30 | 40 | 50 | 60 | 70 | 80 | 90 | 100 |
| Range (Km) | 140 | 160 | 170 | 160 | 140 | 120 | 100 | 90 |
| Effective | 134.4 | 153.6 | 163.2 | 153.6 | 134.4 | 115.2 | 96 | 86.4 |
| Range (with | | | | | | | | |
| ACF = 0.96) | | | | | | | | |

Effective range = Actual range × Air Conditioning Factor (ACF)

Air Conditioning Factor is decided by air conditioning level as given in Table 1D. Actual Range under ideal conditions (with ACF=1) is 100 Km at speed 90 Km/hr. Required Range set by user=120 Km when Air Conditioning Factor (ACF)=0.96. From the table 2D, effective range is more than 120 Km for speed≤70. Suggested adaptive cruise speed to get above range is 70 Km/hr.
At 70 Km/hr, effective range=134.4 Km which is more than required range (120 km) set by the user.
2.5 Range Goal with Variation in Load Factor (LF) in Goods Vehicles
User has total up and down distance of 120 km (say). Either the system (100) checks the load automatically or by manual feed by driver.
Here load is 25% (say). Load Factor LF=0.9 as per Table 1E.
(Vehicle having 2.5-ton load with full capacity of 10-ton load)
Required Range as calculated from map APIs=120 km
Cruise speed set by user=90 km/hr
Adaptive cruise speed setting to complete the journey, is given by the system based on the following method.

TABLE 2E
(LF = 0.9)

| | Speed (Km/hr) | | | | | | | |
|---|---|---|---|---|---|---|---|---|
| | 30 | 40 | 50 | 60 | 70 | 80 | 90 | 100 |
| Range (Km) | 140 | 160 | 170 | 160 | 140 | 120 | 100 | 90 |
| Effective | 126 | 144 | 153 | 144 | 126 | 108 | 90 | 81 |
| Range (with | | | | | | | | |
| LF = 0.9) | | | | | | | | |

Effective range = Actual range × Load Factor (LF)

Load Factor is decided by Load in vehicle as given in Table 1E.
Actual Range under ideal conditions (with LF=1) is 100 Km at speed 90 Km/hr. Required Range set by user=120 Km when Load Factor (LF)=0.9

From the table 2E, effective range is more than 120 Km for speed≤70.

Suggested adaptive cruise speed to get above range is 70 Km/hr.
At 70 Km/hr, effective range=126 Km which is more than required range (120 km) set by the user.
2.6 Range Goal with all Five Factors Taken Together.
If User feeds two or more of above factors, effect taken as follow.

Net factor (NF)=PF×TPF×UF×ACF×LF
Example 1: NF=PF×TPF×UF×ACF×LF=1×1×1×1×1=1 under ideal cases
Example 2: NF=PF×TPF×UF×ACF×LF=0.9×0.98×0.96×0.96×0.9=0.73 under above stated cases
   User has total up and down distance of 120 km. Either the system (100) picks all factors values automatically (say through CAN) or by manual feed by driver
   Here conditions of all above five cases are taken into account.
   Required Range as calculated from map APIs=120 km
   Cruise speed set by user=90 km/hr
   Adaptive cruise speed setting to complete the journey, is given by the system based on the following method.

TABLE 2F
(NF = 0.73)

| Speed (Km/hr) | 30 | 40 | 50 | 60 | 70 | 80 | 90 | 100 | 110 |
|---|---|---|---|---|---|---|---|---|---|
| Range (Km) | 140 | 160 | 170 | 160 | 140 | 120 | 100 | 90 | 70 |
| Effective Range | 102.2 | 116.8 | 124.1 | 116.8 | 102.2 | 87.6 | 73 | 65.7 | 51.1 |
| (with NF = 0.73) | | | | | | | | | |

Effective range = Actual range × Net Factor (NF)

Net Factor is decided multiplication of all five factors discussed above.
Actual Range under ideal conditions (with NF=1) is 100 Km at speed 90 Km/hr. Required Range set by user=120 Km when Net Factor (NF)=0.73
From the Table 2F, effective range is more than 120 Km for speed=50 km/hr. Suggested adaptive cruise speed to get above range is 50 Km/hr.
At 50 Km/hr, effective range=124.1 Km which is more than required range (120 km) set by the user.

### 3 Various Procedural Steps for Adaptive Cruise Speed for Range Goal Method

As shown in FIG. 11A, method steps for achieving Range Goal
Step 1: Check Range at cruise speed set by user or manufacturer, if any.
Example: Range=100 Km at cruise speed=90 Km/hr.
Step 2: Required Range to complete the journey either from Map API or Manual calculation by user.
Example: Required Range=120 Km to complete the journey.
Step 3: Either automatic or manual feed of all five factors PF, TPF, UF, ACF, LF
Step 4: Calculate Net factors as, NF=PF×TPF×UF×ACF×LF
Example: NF=0.9×0.98×0.96×0.96×0.9=0.73
[If any factor is not fed, it is taken as 1]
Step 5: Find speed as per Table 2F. i.e., speed for which effective range is more than 120 Km with given NF. (here NF=0.73).
   Get the corresponding cruise speed from Table 2F.
   As per table 2F, Speed=50 Km/hr.
Step 6: Automatically feed above speed (say 50 km/hr) to adaptive cruise control system or advise Adaptive cruise speed=50 km/hr to user.
   If recommended adaptive cruise speed is not within speed limits permissible by local laws, information/warning is given to user and he can override this warning at his own risk.
Step 7: Display adaptive cruise speed=50 km/hr.
   Either the system (100) feeds thereto automatically or the user does thereto manually.
Step 8: If Range goal is too high and may not be achieved, informs the user
Example: Range goal set by user=130 km when NF=0.73
   Following message appears on the display (132):
“Range goal is not possible with this vehicle. Maximum Range of 124.1 possible at cruise speed of 50 km/hr. Set lower possible Range goal”
Step 9: Adaptive Cruise speed value is transferred to Cruise speed control setup (104) and information is given to the display (132) and PDA (122).

### 4 Adaptive Cruise Speed Setting to Achieve Mileage Goal

The system (100) adapts to cruise speed as per “Mileage goal” of user.

User wants to set Mileage as a goal.
User has certain value of fuel or charge (for Electric Vehicle) and wants to cover certain journey with some Mileage as goal. Mileage depends on the speed of vehicle. User may change mileage by controlling the speed of the vehicle. User may attain desired mileage by getting adaptive cruise speed setting automatically or manually adjust the cruise speed.
Example: A user sets mileage goal as 10 Km/litre, cruise speed setting is 90 Km/hr. Now user modifies and sets mileage goal as 12 km/litre. The system (100) modifies Adaptive cruise speed setting to 80 km/hr. This is as per speed vs mileage characteristics (or graph) of vehicle under standard conditions.

### Relevant Part of Table 1:

| Speed(km/hr) | 70 | 80 | 90 | 100 | 110 |
|---|---|---|---|---|---|
| Mileage (km/litre) | 14 | 12 | 10 | 9 | 7 |

Given table is standard conditions with all factors like PF, TPF, ACF, LF, UF as unity i.e. =1.
4.1 Mileage Goal with Variation in Passenger Factor (PF)
Under Normal condition, Only Driver present. Passenger Factor PF=1
Required Mileage set by user=10 km/litre.
Cruise speed (as per above Table)=90 km/hr.

### Under Driver+2 Passenger, Passenger Factor=0.95 (From Table 1A)

Required Mileage set by user=10 km/litre
Under Normal condition, Only Driver present. Passenger Factor PF=1
Required Mileage set by user=10 km/litre.
Cruise speed (as per above Table)=90 km/hr.

### Under Driver+2 Passenger, Passenger Factor=0.95 (From Table 1A)

Required Mileage set by user=10 km/litre

TABLE 3A
(PF = 0.95)

| Speed (Km/hr) | 30 | 40 | 50 | 60 | 70 | 80 | 90 | 100 | 110 |
|---|---|---|---|---|---|---|---|---|---|
| Mileage (Km/l) | 14 | 16 | 17 | 16 | 14 | 12 | 10 | 9 | 7 |
| Effective Mileage | 13.3 | 15.2 | 16.2 | 15.2 | 13.3 | 11.4 | 9.5 | 8.5 | 6.6 |
| With PF = 0.95 | | | | | | | | | |

Effective Mileage = Actual Mileage × Passenger Factor (PF).

Passenger factor is decided by number of passengers as given in Table 1A.
Actual Mileage under ideal conditions (with PF=1) is 10 km/litre at speed 90 Km/hr.
Required Mileage set by user=12 Km/l when Passenger Factor (PF)=0.95
From the table 3A, effective Mileage is more than 12 Km/l for speed≤70. Suggested adaptive cruise speed to get above Mileage (more than 12 km/l) is 70 Km/hr.
At 70 Km/hr, effective Mileage=13.3 Km/l
At 70 Km/hr, effective Mileage=13.3 Km/l which is more than required Mileage (12 km/l) set by the user.
4.2 Mileage Goal with Variation in Tyre Pressure Factor (TPF)
Under Normal condition, specified tyre pressure. TPF=1
Actual Mileage=10 km/litre when TPF=1 under ideal conditions.
Cruise speed (as per above Table)=90 km/litre.

### When Tyre Pressure Factor TPF=0.98 (From Table 1B)

Required Mileage set by user=12 km/litre

TABLE 3B
(TPF = 0.98)

| [symbol] peed (Km/hr) | [symbol] 0 | [symbol] 0 | [symbol] 0 | [symbol] 0 | [symbol] 0 | [symbol] 0 | [symbol] 0 | [symbol] 00 | [symbol] 10 |
|---|---|---|---|---|---|---|---|---|---|
| [symbol] ileage (Km/l) | [symbol] 4 | [symbol] 6 | [symbol] 7 | [symbol] 6 | [symbol] 4 | [symbol] 2 | [symbol] 0 | [symbol] | [symbol] |
| [symbol] ffective Mileage | [symbol] 3.7 | [symbol] 5.7 | [symbol] 6.6 | [symbol] 5.7 | [symbol] 3.7 | [symbol] 1.7 | [symbol] .8 | [symbol] .8 | [symbol] .86 |
| [symbol] ith TPF = 0.98 | | | | | | | | | |

Effective Mileage = Actual Mileage × Tyre Pressure Factor (TPF). [symbol]
indicates data missing or illegible when filed

Tyre Pressure factor is decided by Tyre Pressures as given in Table 1B.
Actual Mileage under ideal conditions (with TPF=1) is 10 km/l at speed 90 Km/hr. Required Mileage set by user=12 Km/l when Tyre Pressure Factor (TPF)=0.98 From the table 3B, effective Mileage is more than 12 Km/l for speed≤70. Suggested adaptive cruise speed to get above Mileage (more than 12 km/l) is 70 Km/hr.
At 70 Km/hr, effective Mileage=13.7 Km/l
At 70 Km/hr, effective Mileage=13.7 Km/l which is more than required Mileage (12 km/l) set by the user
4.3 Mileage Goal with Variation in Vehicle Use Factor (UF)

### Use Factor, UF=0.96.

TABLE 3C
(UF = 0.96)

| Speed (Km/hr) | 30 | 40 | 50 | 60 | 70 | 80 | 90 | 100 | 110 |
|---|---|---|---|---|---|---|---|---|---|
| Mileage (Km/l) | 14 | 16 | 17 | 16 | 14 | 12 | 10 | 9 | 7 |
| Effective Mileage | 13.4 | 15.4 | 16.32 | 15.4 | 13.44 | 11.52 | 9.6 | 8.64 | 6.72 |
| With UF = 0.96 | | | | | | | | | |

Effective Mileage = Actual Mileage × Use Factor (UF).

Use factor is decided by Use of vehicle as given in Table 1C. Odometer reading is used to get numerical value of use factor.
Actual Mileage under ideal conditions (with UF=1) is 10 km/l at speed 90 Km/hr. Required Mileage set by user=12 Km/l when Use Factor (UF)=0.96
From the Table 3C, effective Mileage is more than 12 Km/l for speed≤70. Suggested adaptive cruise speed to get above Mileage (more than 12 km/l) is 70 Km/hr.
At 70 Km/hr, effective Mileage=13.44 Km/l
At 70 Km/hr, effective Mileage=13.44 Km/l which is more than required Mileage (12 km/l) set by the user
4.4 Mileage Goal with Variation in Air Conditioning (ACF)

### Air Conditioning Factor, ACF=0.96

TABLE 3D
(ACF = 0.96)

| Speed (Km/hr) | 30 | 40 | 50 | 60 | 70 | 80 | 90 | 100 | 110 |
|---|---|---|---|---|---|---|---|---|---|
| Mileage (Km/l) | 14 | 16 | 17 | 16 | 14 | 12 | 10 | 9 | 7 |
| Effective Mileage | 13.4 | 15.4 | 16.32 | 15.4 | 13.44 | 11.52 | 9.6 | 8.64 | 6.72 |
| With ACF = 0.96 | | | | | | | | | |

Effective Mileage = Actual Mileage × Air Conditioning Factor (ACF).

Air conditioning factor is decided by number of Air conditioning setting as given in Table 1D.
Actual Mileage under ideal conditions (with ACF=1) is 10 km/l at speed 90 Km/hr. Required Mileage set by user=12 Km/l when Air conditioning Factor (ACF)=0.96 From the table 3D, effective Mileage is more than 12 Km/l for speed≤70. Suggested adaptive cruise speed to get above Mileage (more than 12 km/l) is 70 Km/hr.
At 70 Km/hr, effective Mileage=13.44 Km/l
At 70 Km/hr, effective Mileage=13.44 Km/l which is more than required Mileage (12 km/l) set by the user.
4.5 Mileage Goal with Variation in Load Factor (LF)

### Load Factor, LF=0.96.

TABLE 3E
(LF = 0.9)

| Speed (Km/hr) | 30 | 40 | 50 | 60 | 70 | 80 | 90 | 100 | 110 |
|---|---|---|---|---|---|---|---|---|---|
| Mileage (Km/l) | 14 | 16 | 17 | 16 | 14 | 12 | 10 | 9 | 7 |
| Effective Mileage | 12.6 | 14.4 | 15.3 | 14.4 | 12.6 | 10.8 | 9.0 | 8.1 | 6.3 |
| With LF = 0.9 | | | | | | | | | |

Effective Mileage = Actual Mileage × Load Factor (LF)

Load factor is decided by load on the vehicle as given in Table 1E.
Actual Mileage under ideal conditions (with LF=1) is 10 km/l at speed 90 Km/hr. Required Mileage set by user=12 Km/l when Load Factor (LF)=0.9
From the table 3E, effective Mileage is more than 12 Km/l for speed≤70. Suggested adaptive cruise speed to get above Mileage (more than 12 km/l) is 70 Km/hr.
At 70 Km/hr, effective Mileage=12.6 Km/l
At 70 Km/hr, effective Mileage=12.6 Km/l which is more than required Mileage (12 km/l) set by the user.
4.6 Mileage Goal with Variation in Net Factor (NF)

### Net Factor NF=0.73

TABLE 3F
(NF = 0.73)

| Speed (Km/hr) | 30 | 40 | 50 | 60 | 70 | 80 | 90 | 100 | 110 |
|---|---|---|---|---|---|---|---|---|---|
| Mileage (Km/l) | 14 | 16 | 17 | 16 | 14 | 12 | 10 | 9 | 7 |
| Effective Mileage | 10.2 | 11.7 | 12.4 | 11.6 | 10.2 | 8.76 | 7.3 | 6.5 | 5.1 |
| With NF = 0.73 | | | | | | | | | |

Effective Mileage = Actual Mileage × Net Factor (NF)

Net factor is decided by all factors discussed above.
Actual Mileage under ideal conditions (with NF=1) is 10 km/l at speed 90 Km/hr. Required Mileage set by user=12 Km/l when Net Factor (NF)=0.73
From the table 3F, effective Mileage is more than 12 Km/l for speed=50. Suggested adaptive cruise speed to get above Mileage (more than 12 km/l) is 50 Km/hr.
At 50 Km/hr, effective Mileage=12.4 Km/l
At 50 Km/hr, effective Mileage=12.4 Km/l which is more than required Mileage (12 km/l) set by the user
Either Net Factor (NF) is fed automatically or manually by the user.

### 5. Various Procedural Steps for Mileage Goal

As shown in FIG. 11B, method steps for achieving Mileage Goal as follows:
Step 1: Check “Mileage” given by Manufacturer or third party (e.g. ARAI Pune, India).
Example: 10 Km/litre at speed 90 Km/hr
Step 2: Required Mileage Goal=12 Km/litre
Step 3: Either automatic or manual feed of all five factors PF, TPF, UF, ACF, LF
Step 4: Calculate Net factor, NF
Example: NF=PF×TPF×UF×ACF×LF=0.9×0.98×0.96×0.96×0.9=0.73
   [If any factor Is not fed, it is taken as 1]
Step 5: Find Mileage as per Table 2F.

| Speed (Km/hr) | 30 | 40 | 50 | 60 | 70 | 80 | 90 | 100 | 110 |
|---|---|---|---|---|---|---|---|---|---|
| Mileage (Km) | 14 | 16 | 17 | 16 | 14 | 12 | 10 | 9 | 7 |
| Effective Mileage | 10.2 | 11.7 | 12.4 | 11.68 | 10.2 | 8.76 | 7.3 | 6.57 | 5.1 |
| With NF = 0.73 | | | | | | | | | |

Mileage ≥12 is possible, only for speed as per above table.
Step 6: Automatically feed to adaptive cruise control or advise.
   Adaptive cruise speed=50 km/hr.
   If recommended adaptive cruise speed is not within speed limits permissible by local laws, information/warning is given to user and he can override this warning at his own risk
Step 7: Display adaptive cruise speed=50 km/hr.
   Either the system (100) sets it automatically or user does it manually.
Step 8: If Mileage goal is too high and cannot be achieved, inform the user
Example: Mileage goal=14 Km/l when TF=0.73
   Following message appears on the display (132):
“(Mileage goal is not possible with this vehicle). Set lower mileage goal”.
Step 9: Adaptive Cruise speed value is transferred to Cruise speed control mechanism (130) and information is given to the display (132) and PDA (122).

### 6 Fuel Cost/km Goal

User has certain value of fuel or charge (for Electric Vehicle) and wants to cover certain journey with some Fuel cost/km as goal. Fuel cost/km depends on the speed of vehicle. User may change Fuel cost/km by controlling the speed of the vehicle. User may attain desired Fuel cost/km by getting adaptive cruise speed setting automatically or manually adjusting the cruise speed.

The system (100) adapts to cruise speed as per “Fuel cost/km goal” of user as and when user wants to set Fuel cost/km as a goal. It is explained through an example below.
Example: A user sets Fuel cost/km goal as INR 9/km, cruise speed setting is 90 Km/hr. Now user modifies and sets Fuel cost/km goal as INR 7.5/km. Need a system to modify Adaptive cruise speed setting to 80 km/hr. This is as per speed vs Fuel cost/km characteristics (or graph) of vehicle under standard conditions with a given fuel price updates as given in Table 1.
   6.1 Fuel Cost/km Goal with Variation in Passenger Factor (PF)

The system (100) adapts to cruise speed as per “Fuel cost/km goal” of user.

User wants to set Fuel cost/km as a goal.

### Passenger Factor (PF) Table 1A

| Passengers | Driver only | Driver + 1 | Driver + 2 | Driver + 3 | Driver + 4 |
|---|---|---|---|---|---|
| PF | 1.0 | 0.95 | 0.90 | 0.85 | 0.80 |

Effective Fuel cost/km=Actual Fuel cost per km/PF

These vehicle Fuel cost v/s speed along with variation due to number of passengers may be given by vehicle manufacturer or 3rd parties in Automobile research or user can find out by performing experiments on his vehicle as per Bureau of Indian Standard BIS 11921 and varying the number of passengers.
Either the system (100) in the vehicle automatically picks data from passenger information module having information about number of passengers or driver/user feeds number of passengers in the input device (102).
Number of passengers in a vehicle can be available from many methods,
Some of which are discussed hereinabove:
As number of passengers increase, Fuel cost/km increases because mileage (km/litre) decreases as given in Table 1
Adaptive cruise speed setting to complete the journey, is given by the system based on the following method.

TABLE 4A
(PF = 0.95)

| Speed (Km/hr) | 30 | 40 | 50 | 60 | 70 | 80 | 90 | 100 | 110 |
|---|---|---|---|---|---|---|---|---|---|
| Cost/Km (in INR/Km) | 6.4 | 5.6 | 5.3 | 5.6 | 6.4 | 7.5 | 9 | 10 | 12.9 |
| Effective Cost/ | 6.7 | 5.89 | 5.57 | 5.89 | 6.7 | 7.89 | 9.47 | 10.52 | 13.57 |
| Km (PF = 0.95) | | | | | | | | | |

Effective Fuel cost/km = Actual Fuel cost per km/PF

Passenger factor is decided by number of passengers as given in Table 1A. Actual Fuel Cost/km under ideal conditions (with PF=1) is 9 INR/km at speed 90 Km/hr.
Required Fuel Cost/km set by user is 7 INR/Km when Passenger Factor (PF)=0.95 From the table 4A, effective Fuel Cost/km is less than 7 INR/km for speed≤70. Suggested adaptive cruise speed to get above Fuel Cost/km (less than 7 INR/km) is 70 Km/hr.
At 70 Km/hr, effective Fuel Cost/km=6.7 INR/Km.
At 70 Km/hr, effective Fuel Cost/km=6.7 INR/Km which is less than required Fuel Cost/km (7 INR/km) set by the user.
6.2 Fuel Cost/km Goal with Variation in Tyre Pressure Factor (TPF)

### Tyre Pressure Factor TPF=0.9.

TABLE 4B
(TPF = 0.98)

| Speed (Km/hr) | 30 | 40 | 50 | 60 | 70 | 80 | 90 | 100 | 110 |
|---|---|---|---|---|---|---|---|---|---|
| Cost/Km (in INR/Km) | 6.4 | 5.6 | 5.3 | 5.6 | 6.4 | 7.5 | 9 | 10 | 12.9 |
| Effective Cost/ | 6.53 | 5.71 | 5.4 | 5.71 | 6.53 | 7.65 | 9.18 | 10.20 | 13.16 |
| Km (PF = 0.98) | | | | | | | | | |

Effective Fuel cost/km = Actual Fuel cost per km/TPF

Tyre Pressure Factor is decided by tyre pressure as given in Table 1B.
Actual Fuel Cost/km under ideal conditions (with TPF=1) is 9 INR/km at speed 90 Km/hr.
Required Fuel Cost/km set by user is 7 INR/Km when Tyre Pressure Factor (TPF)=0.95
From the table 4B, effective Fuel Cost/km is less than 7 INR/km for speed≤70.
Suggested adaptive cruise speed to get above Fuel Cost/km (less than 7 INR/km) is 70 Km/hr.
At 70 Km/hr, effective Fuel Cost/km=6.53 INR/Km.
At 70 Km/hr, effective Fuel Cost/km=6.53 INR/Km which is less than required Fuel Cost/km (7 INR/km) set by the user.
6.3 Fuel Cost/km Goal with Variation in Vehicle Use Factor (UF)

### Use Factor, say UF=0.96

TABLE 4C
(UF = 0.96)

| Speed (Km/hr) | 30 | 40 | 50 | 60 | 70 | 80 | 90 | 100 | 110 |
|---|---|---|---|---|---|---|---|---|---|
| Cost/Km (in INR/Km) | 6.4 | 5.6 | 5.3 | 5.6 | 6.4 | 7.5 | 9 | 10 | 12.9 |
| Effective Cost/ | 6.66 | 5.83 | 5.52 | 5.83 | 6.66 | 7.81 | 9.37 | 10.41 | 13.43 |
| Km (UF = 0.96) | | | | | | | | | |

Effective Fuel cost/km = Actual Fuel cost per km/UF.

Use factor is decided by use of vehicle as given in Table 1C.
Actual Fuel Cost/km under ideal conditions (with UF=1) is 9 INR/km at speed 90 Km/hr.
Required Fuel Cost/km set by user is ≤7 INR/Km when Use Factor (UF)=0.96 From the table 4C, effective Fuel Cost/km is less than 7 INR/km for speed≤70.
Suggested adaptive cruise speed to get above Fuel Cost/km (less than 7 INR/km) is 70 Km/hr.
At 70 Km/hr, effective Fuel Cost/km=6.66 INR/Km.
At 70 Km/hr, effective Fuel Cost/km=6.66 INR/Km which is less than required Fuel Cost/km (7 INR/km) set by the user.
6.4 Fuel Cost/km Goal with Variation in Air Conditioning (ACF) Air Conditioning Factor, say ACF=0.96.

TABLE 4D
(ACF = 0.96)

| Speed (Km/hr) | 30 | 40 | 50 | 60 | 70 | 80 | 90 | 100 | 110 |
|---|---|---|---|---|---|---|---|---|---|
| Cost/Km (in INR/Km) | 6.4 | 5.6 | 5.3 | 5.6 | 6.4 | 7.5 | 9 | 10 | 12.9 |
| Effective Cost/ | 6.66 | 5.83 | 5.52 | 5.83 | 6.66 | 7.81 | 9.37 | 10.41 | 13.43 |
| Km (ACF = 0.96) | | | | | | | | | |

Effective Fuel cost/km = Actual Fuel cost per km/ACF

Air Conditioning Factor is decided by air conditioning level as given in Table 1D. Actual Fuel Cost/km under ideal conditions (with ACF=1) is 9 INR/km at speed 90 Km/hr.
Required Fuel Cost/km set by user is 7 INR/Km when Air conditioning Factor (ACF)=0.96
From the table 4D, effective Fuel Cost/km is less than 7 INR/km for speed≤70. Suggested adaptive cruise speed to get above Fuel Cost/km (less than 7 INR/km) is 70 Km/hr.
At 70 Km/hr, effective Fuel Cost/km=6.66 INR/Km.
At 70 Km/hr, effective Fuel Cost/km=6.66 INR/Km which is less than required Fuel Cost/km (7 INR/km) set by the user.
6.5 Fuel Cost/km Goal with Variation in Load Factor (LF)

### Load Factor, say LF=0.9.

TABLE 4E
(LF = 0.9)

| Speed (Km/hr) | 30 | 40 | 50 | 60 | 70 | 80 | 90 | 100 | 110 |
|---|---|---|---|---|---|---|---|---|---|
| Cost/Km (in INR/Km) | 6.4 | 5.6 | 5.3 | 5.6 | 6.4 | 7.5 | 9 | 10 | 12.9 |
| Effective Cost/ | 7.11 | 6.22 | 5.88 | 6.22 | 7.11 | 8.33 | 10 | 13.7 | 14.33 |
| Km (LF = 0.9) | | | | | | | | | |

Effective Fuel cost/km = Actual Fuel cost per km/LF

Load factor is decided by goods load on vehicle as given in Table 1E.
Actual Fuel Cost/km under ideal conditions (with LF=1) is 9 INR/km at speed 90 Km/hr.
Required Fuel Cost/km set by user is 7 INR/Km when Load Factor (LF)=0.9 From the table 4E, effective Fuel Cost/km is less than 7 INR/km for speed≤70. Suggested adaptive cruise speed to get above Fuel Cost/km (less than 7 INR/km) is 60 Km/hr.
At 60 Km/hr, effective Fuel Cost/km=6.22 INR/Km.
At 60 Km/hr, effective Fuel Cost/km=6.22 INR/Km which is less than required Fuel Cost/km (7 INR/km) set by the user.
6.6 Fuel Cost/km Goal with Variation in Net Factor (NF)

### Net Factor NF=0.73

TABLE 4F
(NF = 0.73)

| Speed (Km/hr) | 30 | 40 | 50 | 60 | 70 | 80 | 90 | 100 | 110 |
|---|---|---|---|---|---|---|---|---|---|
| Cost/Km (in INR/Km) | 6.4 | 5.6 | 5.3 | 5.6 | 6.4 | 7.5 | 9 | 10 | 12.9 |
| Effective Cost/ | 8.76 | 7.67 | 7.26 | 7.67 | 8.76 | 10.27 | 12.32 | 13.7 | 17.67 |
| Km (NF = 0.73) | | | | | | | | | |

Either Net Factor (NF) is fed automatically or manually by the user.

Effective Fuel cost/km=Actual Fuel cost per km/NF.

Actual Fuel Cost/km under ideal conditions (with NF=1) is 9 INR/km at speed 90 Km/hr.
Required Fuel Cost/km set by user is 8 INR/Km when Net Factor (NF)=0.95 From the table 4F, effective Fuel Cost/km is less than 8 INR/km for 40≤speed≤60. i.e., Speed in between 40 and 60 km/hr.
Suggested adaptive cruise speed to get above Fuel Cost/km (less than 7 INR/km) is 60 Km/hr.
At 60 Km/hr, effective Fuel Cost/km=7.67 INR/Km.
At 60 Km/hr, effective Fuel Cost/km=7.67 INR/Km which is less than required Fuel Cost/km (8 INR/km) set by the user.

### 7 Various Procedural Steps for Fuel Cost/Km Goal

As shown in FIG. 11C, method steps for achieving Fuel cost/km Goal as follows:
Step 1: Check Fuel Cost/Km at cruise speed set by user or manufacturer.
Example: Cost/Km=9 INR/Km at cruise speed=90 Km/hr.
Step 2: Required Cost/Km either from Map API or Manual calculation by user.
Example: Required Cost/Km=8 INR/Km
Step 3: Either automatic or manual feed of all five factors PF, TPF, UF, ACF, LF
Step 4: Calculate Net factor, NF
Example: NF=PF×TPF×UF×ACF×LF=0.9×0.98×0.96×0.96×0.9=0.73
   [If any factor Is not fed, it is taken as 1]
Step 5: Find speed as per Table 4F here speed value is between 40 km/hr to 60 km/hr

TABLE 4F
(NF = 0.73)

| Speed (Km/hr) | 30 | 40 | 50 | 60 | 70 | 80 | 90 | 100 | 110 |
|---|---|---|---|---|---|---|---|---|---|
| Cost/Km (in INR/Km) | 6.4 | 5.6 | 5.3 | 5.6 | 6.4 | 7.5 | 9 | 10 | 12.9 |
| Effective Cost/ | 8.76 | 7.67 | 7.26 | 7.67 | 8.76 | 10.27 | 12.32 | 13.7 | 17.67 |
| Km (NF =0.73) | | | | | | | | | |

Effective Fuel cost/km = Actual Fuel cost per km/NF.

Step 6: Automatically feed to adaptive cruise control or advise.
   Adaptive cruise speed=60 km/hr.
   If recommended adaptive cruise speed is not within speed limits permissible by local laws, information/warning is given to user and he can override this warning at his own risk
Step 7: Display adaptive cruise speed=60 km/hr.
   The system (100) either sets it automatically or user does it manually.
Step 8: If Fuel cost/km goal is too low and cannot be achieved, inform the user
Example: Cost/km goal=6 INR/km when TF=0.73
   Following message appears on the display (132)
   “Cost/km goal is not possible with this vehicle. Set higher value of cost/km goal”.
Step 9: Adaptive Cruise speed value is transferred to Cruise speed control mechanism (130) and information is given to the display (132) and PDA (122).

### 8 Fuel Volume/km Goal

User has certain value of fuel or charge (for Electric Vehicle) and wants to cover certain journey with some Fuel Volume/km as goal. Fuel Volume/km depends on the speed of vehicle. User can change Fuel Volume/km by controlling the speed of the vehicle. User can attain desired Fuel Volume/km by getting adaptive cruise speed setting automatically or manually adjusting the cruise speed

The system (100) adapts to cruise speed as per “Fuel volume/km goal” of user. User wants to set Fuel volume/km as a goal. User aims to save environment by setting low fuel volume/km as a goal. This is slightly different from Fuel Cost/km goal as cost/km keeps on varying with change in fuel prices with time or with variation in geographic locations (states/country etc.). Once set by user, Fuel volume/km remains same say 100 millilitres for 1 km distance covered.

The system (100) adapts to cruise speed as per “Fuel Volume/km goal” of user as and when user wants to set Fuel volume/km as a goal. It is explained through an example below
Example: A user sets Fuel volume/km goal as 100 ml/km, cruise speed setting is 90 Km/hr. Now user modifies and sets Fuel volume/km goal as 80 ml/km. Need a system to modify Adaptive cruise speed setting to achieve fuel volume/km goal of 80 ml/km. This is as per speed vs Fuel volume/km characteristics (or graph) of vehicle under standard conditions. (Fuel volume/km is inversely proportional to mileage.)
   8.1 Fuel Volume/km Goal with Variation in Passenger Factor (PF)

### Passenger Factor PF=0.95

TABLE 5A
(PF = 0.95)

| Speed (Km/hr) | 30 | 40 | 50 | 60 | 70 | 80 | 90 | 100 | 110 |
|---|---|---|---|---|---|---|---|---|---|
| Fuel Volume (in ml/Km) | 71.4 | 62.5 | 58.8 | 62.5 | 71.4 | 83.3 | 100 | 111 | 143 |
| Effective Fuel Volume/ | 75.15 | 65.78 | 61.89 | 65.78 | 75.15 | 87.68 | 105.62 | 116.84 | 150.52 |
| Km (PF = 0.95) | | | | | | | | | |

Effective Fuel Volume/km = Actual Fuel Volume per km/PF

Passenger factor is decided by number of passengers as given in Table 1A.
Actual Fuel Volume/km under ideal conditions (with PF=1) is 100 ml/km at speed 90 Km/hr.
Required Fuel Volume/km set by user is 80 ml/Km when Passenger Factor (PF)=0.95
From the table 5A, effective Fuel Vol/km is less than 80 ml/km for 30≤speed≤70. Suggested adaptive cruise speed to get above Fuel Volume/km (less than 80 ml/km) is 70 Km/hr.
At 70 Km/hr, effective Fuel Volume/km=75.15 ml/Km.
At 70 Km/hr, effective Fuel Volume/km=75.15 ml/Km which is less than required Fuel Volume/km (80 ml/km) set by the user.
8.2 Fuel Volume/km Goal with Variation in Tyre Pressure Factor (TPF)
Tyre Pressure factor TPF=0.98

TABLE 5B
(TPF = 0.98)

| Speed (Km/hr) | 30 | 40 | 50 | 60 | 70 | 80 | 90 | 100 | 110 |
|---|---|---|---|---|---|---|---|---|---|
| Fuel Volume (in ml/Km) | 71.4 | 62.5 | 58.8 | 62.5 | 71.4 | 83.3 | 100 | 111 | 143 |
| Effective Fuel Volume/ | 72.85 | 63.77 | 60 | 63.77 | 72.85 | 85 | 102 | 113.26 | 145.91 |
| Km (TPF = 0.98) | | | | | | | | | |

Effective Fuel Volume/km = Actual Fuel volume per km/TPF.

Tyre Pressure Factor (TPF) is decided by tyre pressure as given in Table 1B.
Actual Fuel Volume/km under ideal conditions (with TPF=1) is 100 ml/km at speed 90 Km/hr.
Required Fuel Volume/km set by user is 80 ml/Km when Tyre Pressure Factor (TPF)=0.95
From the table 5B, effective Fuel Volume/km is less than 80 ml/km for speed≤70. Suggested adaptive cruise speed to get above Fuel Volume/km (less than 80 ml/km) is 70 Km/hr.
At 70 Km/hr, effective Fuel Volume/km=72.85 ml/Km.
At 70 Km/hr, effective Fuel Volume/km=72.85 ml/Km which is less than required Fuel Volume/km (80 ml/km) set by the user.
8.3 Fuel Volume/km Goal with Variation in Vehicle Use Factor (UF)
Use factor UF=0.96

TABLE 5C
(UF = 0.96)

| Speed (Km/hr) | 30 | 40 | 50 | 60 | 70 | 80 | 90 | 100 | 110 |
|---|---|---|---|---|---|---|---|---|---|
| Fuel Volume (in ml/Km) | 71.4 | 62.5 | 58.8 | 62.5 | 71.4 | 83.3 | 100 | 111 | 143 |
| Effective Fuel Volume/ | 74.37 | 65.10 | 61.25 | 65.10 | 74.37 | 86.77 | 104.16 | 115.62 | 148.95 |
| Km (UF = 0.96) | | | | | | | | | |

Effective Fuel Volume/km = Actual Fuel volume per km/UF.

Use Factor (UF) is decided by odometer reading as given in Table 1C.
Actual Fuel Volume/km under ideal conditions (with UF=1) is 100 ml/km at speed 90 Km/hr.
Required Fuel Volume/km set by user is 80 ml/Km when Use Factor (UF)=0.95 From the table 5C, effective Fuel Vol/km is less than 80 ml/km for 30≤speed≤70. Suggested adaptive cruise speed to get above Fuel Volume/km (less than 80 ml/km) is 70 Km/hr.
At 70 Km/hr, effective Fuel Volume/km=74.37 ml/Km.
At 70 Km/hr, effective Fuel Volume/km=74.37 ml/Km which is less than required Fuel Volume/km (80 ml/km) set by the user.
8.4 Fuel Volume/km Goal with Variation in Air Conditioning (ACF)

### Air Conditioning Factor=0.96

TABLE 5D
(ACF = 0.96)

| Speed (Km/hr) | 30 | 40 | 50 | 60 | 70 | 80 | 90 | 100 | 110 |
|---|---|---|---|---|---|---|---|---|---|
| Fuel Volume (in ml/Km) | 71.4 | 62.5 | 58.8 | 62.5 | 71.4 | 83.3 | 100 | 111 | 143 |
| Effective Fuel Volume/ | 74.37 | 65.10 | 61.25 | 65.10 | 74.37 | 86.77 | 104.16 | 115.62 | 148.95 |
| Km (ACF = 0.96) | | | | | | | | | |

Effective Fuel Volume/km = Actual Fuel volume per km/ACF

Air conditioning Factor (ACF) is decided by air conditioning level as given in Table 1D.
Actual Fuel Volume/km under ideal conditions (with ACF=1) is 100 ml/km at speed 90 Km/hr.
Required Fuel Volume/km set by user is 80 ml/Km when Air Conditioning Factor (ACF)=0.96
From the table 5C, effective Fuel Volume/km is less than 80 ml/km for speed=<70. Suggested adaptive cruise speed to get above Fuel Volume/km (less than 80 ml/km) is 70 Km/hr.
At 70 Km/hr, effective Fuel Volume/km=74.37 ml/Km.
At 70 Km/hr, effective Fuel Volume/km=74.37 ml/Km which is less than required Fuel Volume/km (80 ml/km) set by the user.
8.5 Fuel Volume/km Goal with Variation in Load Factor (LF)

### Load Factor LF=0.9

TABLE 5E
(LF = 0.9)

| Speed (Km/hr) | 30 | 40 | 50 | 60 | 70 | 80 | 90 | 100 | 110 |
|---|---|---|---|---|---|---|---|---|---|
| Fuel Volume (in ml/Km) | 71.4 | 62.5 | 58.8 | 62.5 | 71.4 | 83.3 | 100 | 111 | 143 |
| Effective Fuel Volume/ | 79.33 | 69.44 | 65.33 | 69.44 | 79.33 | 92.55 | 111.11 | 123.33 | 158.88 |
| Km (LF = 0.9) | | | | | | | | | |

Effective Fuel Volume/km = Actual Fuel volume per km/LF

Load Factor (LF) is decided by Load on vehicle as given in Table 1E.
Actual Fuel Volume/km under ideal conditions (with LF=1) is 100 ml/km at speed 90 Km/hr.
Required Fuel Volume/km set by user is 80 ml/Km when Load Factor (LF)=0.9 From the table 5E, effective Fuel Vol/km is less than 80 ml/km for 30≤speed≤70. Suggested adaptive cruise speed to get above Fuel Volume/km (less than 80 ml/km) is 70 Km/hr.
At 70 Km/hr, effective Fuel Volume/km=79.33 ml/Km.
At 70 Km/hr, effective Fuel Volume/km=79.33 ml/Km which is less than required Fuel Volume/km (80 ml/km) set by the user.
8.6 Fuel Volume/km Goal with Variation in Net Factor (NF)

### Net Factor NF=0.73

TABLE 5F
(NF = 0.73)

| Speed (Km/hr) | 30 | 40 | 50 | 60 | 70 | 80 | 90 | 100 | 110 |
|---|---|---|---|---|---|---|---|---|---|
| Fuel Volume (in ml/Km) | 71.4 | 62.5 | 58.8 | 62.5 | 71.4 | 83.3 | 100 | 111 | 143 |
| Effective Fuel Volume/ | 97.80 | 85.61 | 80.54 | 85.61 | 97.80 | 114.10 | 136.98 | 152.05 | 195.89 |
| Km (NF = 0.73) | | | | | | | | | |

Effective Fuel Volume/km = Actual Fuel volume per km/NF.

Net Factor (NF) is decided by all factors discussed above.
Actual Fuel Volume/km under ideal conditions (with NF=1) is 100 ml/km at speed 90 Km/hr.
Required Fuel Volume/km set by user is 85 ml/Km when Net Factor (NF)=0.73 From the table 5F, effective Fuel Volume/km is less than 85 ml/km for speed=50. Suggested adaptive cruise speed to get above Fuel Volume/km (less than 85 ml/km) is 50 Km/hr.
At 50 Km/hr, effective Fuel Volume/km=80.54 ml/Km.
At 50 Km/hr, effective Fuel Volume/km=80.54 ml/Km which is less than required Fuel Volume/km (85 ml/km) set by the user.

### 9 Various Procedural Steps for Fuel Volume/Km Goal

As shown in FIG. 11D, method steps for achieving Fuel Volume/km Goal as follows:
Step 1: Check Fuel Volume/Km at cruise speed set by user or manufacturer.
Example: Fuel Volume/Km=100 ml/km at cruise speed=90 Km/hr.
Step 2: Required Fuel Volume/Km either from Map API or Manual calculation by user.
Example: Required Fuel Volume/Km=85 ml/km
Step 3: Either automatic or manual feed of all five factors PF, TPF, UF, ACF, LF
Step 4: Calculate Net factor, NF
Example: NF=PF×TPF×UF×ACF×LF=0.9×0.98×0.96×0.96×0.9=0.73 (say)
   [If any factor Is not fed, it is taken as 1]
Step 5: Find speed as per Table 5F. For Example, Speed=50 Km/hr.

TABLE 5F
(NF = 0.73)

| Speed (Km/hr) | 30 | 40 | 50 | 60 | 70 | 80 | 90 | 100 | 110 |
|---|---|---|---|---|---|---|---|---|---|
| Fuel Volume (in ml/Km) | 71.4 | 62.5 | 58.8 | 62.5 | 71.4 | 83.3 | 100 | 111 | 143 |
| Effective Fuel Volume/ | 97.80 | 85.61 | 80.54 | 85.61 | 97.80 | 114.10 | 136.98 | 152.05 | 195.89 |
| Km (NF = 0.73) | | | | | | | | | |

Effective Fuel Volume/Km ≤85 ml/km is possible only for speed = 50 km/hr

Step 6: Automatically feed to adaptive cruise control or advise.
   Adaptive cruise speed=50 km/hr
   If recommended adaptive cruise speed is not within speed limits permissible by local laws, information/warning is given to user and he can override this warning at his own risk
Step 7: Display adaptive cruise speed=50 km/hr
   The system (100) either sets it automatically or user does it manually.
Step 8: If Fuel volume/km goal is too low and may not be achieved, inform the user.
Example: Volume/km goal=80 ml/km when TF=0.73
   Following message appears on the display (132)
   “Fuel Volume/km goal is not possible with this vehicle. Set higher Fuel volume/km goal”.”
Step 9: Adaptive Cruise speed value is transferred to Cruise speed control setup (104) and information is given to the display (132) and the PDA (122)

### 10 Travel Distance & Time Restrictions Compliance Goal in Different Geographical Areas.

System may adapt to cruise speed as per Travel distance & time restrictions compliance in different geographical areas of user.

User wants to set “Travel distance & time restrictions” as a goal.
Example: A user has a cruise speed setting of 90 Km/hr. As per local traffic laws, user must cross forest area of 100 km within 1 hour as exit is not allowed after 1 hr of his entry time. Length of the route is 100 km. User cruise speed setting is 90 Km/hr. Need a system to modify adaptive cruise speed as 100 km/hr to cross the area. This is as per compliance of local traffic or other laws of the given geographic area. All local traffic laws and rules are available as data from cloud server in system. It is automatically fed to system. User can feed this data manually for given geographical area.
Example: An aeroplane is moving at cruise speed of 1000 km/hr and landing runway is 800 km away. Runway may be available for landing after 1 hr only. Need a system to modify adaptive cruise speed to 800 km/hr to avoid traffic congestion in air space near airport, reduce load on Air Traffic control system, avoid mid-air collision and reduce pollution near airports.

Similar examples can be given for trains approaching a railway station, cars approaching a charging station for EV charging, buses approaching a bus stand, ships approaching a sea port.

The system (100) is configured to adapt, train and assist the user to use the vehicle at optimum speed to reduce fuel cost/km, reduce pollution, to refill/charge vehicle as per geographical constraints forecast and to achieve other above stated goals through audio/video instructions.

As travel distance & time restrictions are functions of Range, speed, calculation and procedure for this case are same as discussed in previous 4 cases. Application methods are slightly different and will be explained here through different use cases.

Travel distance & time restrictions in geographical area are available as Map API and are conveyed to system through cloud server (126).

### 11 Multiple Goals

User may set multiple goals. For example, a user may set Range goal of 100 km, Mileage Goal of 10 Km/litre, Cost/km Goal of 9 INR/km and Fuel Volume Goal of 100 millilitre/km for a given Net Factor (NF) of 0.73 (say). All these goals are achieved by suggesting Adaptive Cruise Speed of 70 km/hr. It is as per (Table 2F), (Table 3F), (Table 4F) and (Table 5F). As per these four tables, at Adaptive Cruise speed of 70 Km/hr, Range is 102.2 Km, Mileage is 10.2 km/litre, Cost/km is 8.7 INR/km and Fuel Volume/km is 97.8 millilitre/km which is as per required Range goal of more than 100 km, Mileage Goal of more than 10 km/litre, Cost INR/km Goal of less than 9 INR/km and Fuel Volume Goal of less than 100 millilitre/km for a given Net Factor (NF) of 0.73 (say).

### Use Cases

### 13) Use Case 1: Refer FIG. 3

Available fuel=10 litre
Route length=60 km up+60 km down=120 km
Fuel pump at 1 and 2 points are available.
User has crossed point 1 and fuel station at 2 are not working due to any reason. [say timing is over, workers strike, non-availability of fuel due to any reason]
User has set cruise speed=90 km/hr
Problem: User may not come back to point 1 as vehicle will run out of fuel as up and down distance to be covered=120 km.
Maximum distance (Range) which can be covered at speed 90 km/hr (mileage 10 km/litre) with a fuel of 10 litre=10 km/litre×10 litre=100 km
So, vehicle may not come back to starting point because vehicle may run out of Fuel or battery is discharged.
Solution: If the set cruise speed is changed from 90 km/hr to 80 km/hr, the new mileage is 12 km/litre as per the standard speed vs mileage graph of the vehicle. Now if performing calculations again.
Maximum distance which can be covered at speed 90 km/hr (mileage 12 km/litre) with a fuel of 10 litre=12 km/litre×10 litre=120 km
Now, vehicle can come back to starting point without running out of fuel or charge. Procedure for the Use Case 1 is as follows:
Step 1: User to enter start and end location on Map solution application
Step 2: Map API to fetch fuel availability along with fuel prices along the route, up and down journey.
Step 3: MAP API to get total distance (say 120 km) to be covered.
Step 4: The system (100) to measure fuel in tank (or charge in battery) and corresponding Range (say 100 km) at set cruise speed (say 90 km/hr) under standard conditions as per Table 1.
Step 5: System to give audio/visual warning to user that vehicle may not come back if present cruise speed is maintained. The system (100) give advisory to set a new cruise speed (say 80 km/hr) for which Range is sufficient (say 120 km) so that user can come back without refuelling or recharging. System can automatically set adapted cruise speed (80 km/hr) and inform the user about new adapted cruise speed (80 km/hr)
Step 6: The system (100) to check Net Factor (NF) and do steps 4 and 5 again as per new adapted speed at NF (say 0.73). The system (100) checks all multiple goals set by user discussed in description and set/recommend new adapted speed as per the methods discussed in description earlier.
Step 7: If new adapted speed with NF equal to 0.73 is 50 km/hr, User can manually set new adapted cruise speed (50 km/hr) OR The system (100) set new adapted cruise speed (50 km/hr) OR user can manually override all these warnings/advisories and set any speed of user's choice at his own risk.

### 14 Use Case 2: Reference to FIG. 4

Available fuel=10 litre
Route length 1 to P in state A=120 km
In state A, route 1 to P, either fuel pumps are not available OR Fuel price in state A is high in comparison to state B. Fuel pumps are available in path P to 2 in state B. User may not want to refill between 1 to P due any reason and wants to get refill at or after point P.
User has set cruise speed=90 km/hr
Problem: User may not reach point P as vehicle may run out of fuel as distance to be covered=120 km.
Maximum distance (Range) which can be covered at speed 90 km/hr (mileage 10 km/litre) with a fuel of 10 litre=10 km/litre×10 litre=100 km
So, vehicle may not reach point P because vehicle will run out of Fuel or battery is discharged.
Solution: If the set cruise speed is changed from 90 km/hr to 80 km/hr, the new mileage is 12 km/litre as per the standard speed vs mileage graph of the vehicle. Now if we do the calculations again
Maximum distance which can be covered at speed 80 km/hr (mileage 12 km/litre) with a fuel of 10 litre=12 km/litre×10 litre=120 km
Now, vehicle can cross point P without running out of fuel or charge.
Procedure for this use case 1 is as follows
Step 1: User to enter start and end location on Map solution application
Step 2: Map API to fetch fuel availability along with fuel prices along the route in state A and State B along with fuel price and distance of border point P and fuel station distances.
Step 3: MAP API to get distance 1 to P (say 120 km) to be covered.
Step 4: The system (100) to measure fuel in tank (or charge in battery) and corresponding Range (say 100 km) at set cruise speed (say 90 km/hr) under standard conditions as per Table 1.
Step 5: The system (100) to give audio/visual warning to user that vehicle may not cross point P if present cruise speed is maintained. The system (100) give advisory to set a new cruise speed (say 80 km/hr) for which Range is sufficient (say 120 km) so that user can cross point P without refuelling or recharging. System can automatically set adapted cruise speed (80 km/hr) and inform the user about new adapted cruise speed (80 km/hr) on the display (132).
Step 6: The system (100) to check Net Factor (NF) and do steps 4 and 5 again as per new adapted speed at NF (say 0.73). The system (100) checks all multiple goals set by user discussed in description and set/recommend new adapted speed as per the methods discussed hereinabove.
Step 7: If new adapted speed with NF equal to 0.73 is 50 km/hr, User may manually set new adapted cruise speed (50 km/hr) OR the system (100) may set new adapted cruise speed (50 km/hr) OR user can manually override all these warnings/advisories and set any speed of user's choice at his own risk.

### 15. Use Case 3: FIG. 5A

Vehicle Fuel Tank Capacity=60 litre
Available Fuel=10 litre
Starting point 1 is State A (Say Punjab)
Destination point 2 is State C (say Rajasthan)
Passing through the State B (say Haryana)
Distance between starting point 1 and destination point 2 is 360 km

### Route: 1 to P to Q to 2

Route length in State A: 1 to P (say 20 km)
Route length in State B: P to Q (say 40 Km)
Route length in State C: Q to 2 (say 300 km)
Mileage of vehicle as per standard speed vs mileage characteristics (Table 1)

| Speed(km/hr) | 70 | 80 | 90 | 100 | 110 |
|---|---|---|---|---|---|
| Mileage (km/litre) | 14 | 12 | 10 | 9 | 7 |

### (Here Net Factor=1)

As per previous history stored in vehicle memory storage or permissible speed is 90 km/hr or User Cruise control speed is 90 km/hr or average mileage as per history of user or approximate mileage given by manufacturer at speed 90 km/hr is 10 km/litre.
By any of above or some other mentioned vehicle declared/calculated/measured mileage is 10 km/litre (say).
If various factors (PF, TPF, UF, ACF, LF) are fed by user, mileage calculation is as per NF as discussed in earlier description.
Total Fuel requirement to complete journey=360 km/(10 km/litre)=36 litre Fuel prices in three states (Geographical area) enroute

| State | Fuel Price (Rs/litre) |
|---|---|
| A | 88 |
| B | 90 |
| C | 95 |

The system (100) performs following steps for use case 3:
Step 1: Measure fuel in fuel tank by known methods and inform to CPU/microcontroller.
Step 2: Microcontroller (152) puts in “Fuel tank capacity” from vehicle specification data memory chip/storage.
   Say fuel tank capacity=60 litre
Step 3: CPU will find max possible refill volume at this stage=Fuel Tank capacity−Fuel Available=60 litre−10 litre=50 litres
Step 4: Get route length (say 360 km) from GPS or Map solutions APIs (ONLINE or OFFLINE) as user feeds in starting and end points. Also get route lengths in each state A, B and C.
Step 5: Find names and fuel prices of states (here A, B, C) through which route passes and get data from cloud in following format.

| | | |
|---|---|---|
| State | Route Length | Fuel Prices (Rs/litre) |

| | | | |
|---|---|---|---|
| A | 20 | km | 88 |
| B | 40 | km | 90 |
| C | 300 | km | 95 |

Step 6: Identify states where fuel price is lowest, highest and arrange them in increasing order or decreasing order as per fuel prices.
Step 7: Display fuel prices on maps display with lowest fuel prices in (say in green) and highest (say in Red)
Step 8: Advise the user to get remaining refill capacity of 50 litre to be filled from lowest prices in state A (Punjab) which is user's starting position.
   These advisories may be “text written” or “Audio advisories” or “Animations” or Audio/Video/Animation/Text pop up on Map display of user audio/video output display used. [Screen, LCD, LED, infotainment, multi-information display, speedometer etc.]
   Advisories may be of the following type:
“Dear user, your starting point state A (say Punjab) has lowest fuel price of INR88/lt. You can save INR7 [INR 95−INR 88] per litre on your trip.”
Or
“Your trip fuel cost will be reduced by INR 350 if you get your fuel tank filled here. Save INR 350. Wish you safe journey.”
Or
“Get your tank filled with 50 litres here and save INR 350 [Rs 7/litre×50 litres] fuel filled within 20 km as prices will change in next state B (say Haryana).”
Step 9: If user misses refill in State A due to any reason, the system (100) again performs the above process taking “P” as starting point or existing location of user as starting point and point 2 as end point.
   Now the advisory may be in the complete form.
   “Dear user, your starting state B (say Haryana) is having lower prices in comparison to your end point state C (say Rajasthan).
   You can save INR 5/litre [INR 95−INR90].
   Get your tank filled with 52 litres here.
   [2 litre fuel has been consumed in State A for 20 km route length 1 to P. The system (100) recalculates available refill capacity (52 litres) and save INR 260 (INR 5/litre×52 litres)]
Step 10: User can set a prefixed time of (say 1) hr each or prefixed distance (say 10 km) before crossing of border of state where fuel prices of bordering states are different to inform/warn/advise the user for tank refill advisory based on optimum fuel prices of states en route.
Step 11: Auto reset of cruise speed control (say from 90 km/litre to 80 km/litre to over some distance in high fuel price area to low fuel price area. It is done as per various goals set by user discussed hereinabove.

### 16. Use Case 4: Reference to FIG. 5B

Vehicle Fuel Tank Capacity=60 litre
Available Fuel=2 litre
Starting point 1 in State A (say Punjab)
Destination point 2 in State C (say Rajasthan)
Passing Through the State B (say Haryana) OR state D (say U.P)
Distance between starting point 1 and destination point 2 is 360 km.
Route Option One: 1 to P to Q to 2 (Total length 360 km)
Route length in State A: 1 to P (say 20 km)
Route length in State B: P to Q (say 40 Km)
Route length in State C: Q to 2 (say 300 km)
Route Option two: 1 to R to S to 2 (Total length 360 km)
Route length in State A: 1 to R (say 24 km)
Route length in State D: R to S (say 36 Km)
Route length in State C: Q to 2 (say 300 km)

### Mileage of Vehicle as Per Standard Speed Vs Mileage Characteristics (Table 1)

| Speed(km/hr) | 70 | 80 | 90 | 100 | 110 |
|---|---|---|---|---|---|
| Mileage (km/litre) | 14 | 12 | 10 | 9 | 7 |

As per previous history stored in vehicle memory storage or permissible speed is 90 km/hr or User Cruise control speed is 90 km/hr or average mileage as per history of user or approximate mileage given by manufacturer at speed 90 km/hr is 10 km/litre.
By any of above or some other mentioned vehicle declared/calculated/measured mileage is 10 km/litre (say)
Total Fuel requirement to complete journey=360 km/(10 km/litre)=36 litre

### Fuel Prices in Four States (Geographical Area) En Route are

| State | Fuel Price (Rs/litre) |
|---|---|
| A | 88 |
| B | 90 |
| C | 95 |
| D | 78 |

The System (100) performs following steps:
Step 1: Measure fuel in fuel tank by known methods and inform to CPU/microcontroller.
Step 2: Microcontroller (152) puts in “Fuel tank capacity” from vehicle specification data memory chip/storage. Say fuel tank capacity=60 litre
Step 3: CPU will find max possible refill volume at this stage.=Fuel Tank capacity−Fuel Available=60 litre−2 litre=58 litre
Step 4: Get route length (say 360 km) from GPS or Map solutions APIs (ONLINE or OFFLINE) as user feeds in starting and end points. Also get route lengths in each state A, B, C and D.
Step 5: Find names and fuel prices of states (here A, B, C and D) through which route passes and get data from cloud in following format.

### Route One

| | | |
|---|---|---|
| State | Route Length | Fuel Prices (Rs/litre) |

| | | | |
|---|---|---|---|
| A | 20 | km | 88 |
| B | 40 | km | 90 |
| C | 300 | km | 95 |

### Route Two

| | | |
|---|---|---|
| State | Route Length | Fuel Prices (Rs/litre) |

| | | | |
|---|---|---|---|
| A | 24 | km | 88 |
| D | 36 | km | 78 |
| C | 300 | km | 95 |

Step 6: Identify states where fuel price is lowest, highest and arrange them in increasing order or decreasing order as per fuel prices. Do the same for both routes one and two.
Step 7: Display (122) and temporary store in memory for the system (100), fuel prices on maps display with lowest fuel prices in (say in green) and highest (say in Red) for all states for both routes.
Step 8: Available fuel (2 litre) is sufficient to cover only 20 Km at speed of 90 km/hr. (Mileage 10 km/litre at speed 90 km/hr as per Table 1).
   The system (100) compares route one and route two lengths in each state along with fuel prices.
   The system (100) advises adaptive reduced speed of 80 km/hr to cover 24 km distance (1 to R) and refill in state D (reduced fuel price of 78 INR/litre).
   It is done as per various goals set by user discussed in description so far.
   Advise the user to get remaining refill capacity of 58 litre to be filled from lowest prices in state D.
   The system (100) advises to opt for Route two i.e., Refill in state D (not state B). It will result in saving=INR 12/litre×58 litre=INR 696.
   Fuel Bill saving of INR 696 advisory can be given to user for manual or automatic adaptive speed control with a display.
   These advisories can be “text written” or “Audio advisories” or “Animations” or Audio/Video/Animation/Text pop up on Map display of user audio/video output display used. [Screen, LCD, LED, infotainment, multi-information display, speedometer etc]
   Advisories may be of the following type:
“Dear user, state D has lowest fuel price of INR78/lt.
You can save INR12 [INR 90−INR 78] per litre on your trip if you follow Route two through state D”
Or
“Your trip fuel cost will be reduced by INR 696 if you get your fuel tank filled in state D. Wish you safe journey.”
Or
“Get your tank filled with 58 litre in state D and save INR696 [INR 12/litre×58 litre] fuel filled after covering 24 km on route two, and enter state D as prices in state D are lowest”
Step 9: If user misses refill in State D due to any reason, the system (100) re does the above process.
Step 10: User can set a prefixed time of (say 1) hr each or prefixed distance (say 10 km) before crossing of border of state where fuel prices of bordering states are different to inform/warn/advise the user for tank refill advisory based on optimum fuel prices of states en route.
Step 11: Auto reset of cruise speed control (say from 90 km/litre to 80 km/litre to cover some distance in high fuel price area to low fuel price area on two different routes as per above steps logic. It is done as per various goals set by user discussed in description so far.

### 17 Use Case 5: FIG. 6

Vehicle is at point 1 at certain time (say 6 PM).
Entry point P (in state B) has in time after 8 PM and exit point Q has exit time before 9 PM (say).
Distance 1 to P=160 km and distance P to Q=100 km.
Vehicle present set cruise speed is 90 km/hr.
Vehicle will reach point P in 1 hr 47 minutes.
Entry at P is allowed only after 2 hrs i.e., by 8 PM only.
Step 1: The system (100) fetches all entry and exit times of all geographic areas en route.
Step 2: The system (100) advises the adaptive cruise speed of 80 km/hr to cover 160 km and reach just in time at P at 8 PM. It will reduce cost/km and reduce pollution as discussed hereinabove.
   (It avoids traffic jams/parking fee/waiting charges etc at point P)
Step 3: The system (100) automatically sets Adaptive cruise speed of 80 km/hr to cover 160 km and reach just in time at P at 8 PM. It may be informed to user who can accept or manually override it.
Step 4: The system (100) advises adaptive cruise speed of 100 km/hr so that vehicle exits point Q within one hour i.e., 9 PM.
Step 5: The system (100) automatically sets Adaptive cruise speed of 100 km/hr to cover 100 km (P to Q) and reach just in time at Q at 9 PM. It may be informed to user who can accept or manually override it. It is done as per various goals set by user discussed hereinabove.

### 18 Use Case 6: Reference to FIG. 7

The system (100) is configured to set/advise to just reach in time at station X.
As an example, X is a charging station at distance 80 km from point 1.
At present, vehicle is cruising at speed 90 km/hr. Vehicle may reach station X in 8/9 hrs. Charging port may be available after one hour only. Vehicle may have to wait 1/9 hrs.
So, the system (100) may be configured to set/advise adaptive cruise speed of 80 km/hr so that vehicle reaches in 1 hour i.e., Just in time to avoid any waiting/traffic jam etc. at station X.
Another example is, station X is 100 km and vehicle is cruising at 90 km/hr. Station X will close after one hour.
So, the system (100) may be configured to set/advise adaptive cruise speed of 100 km/hr so that vehicle reaches in 1 hour i.e., Just in time to avoid delay for charging. Procedural steps to be followed are almost same as use case 5.

### 19) Use Case 7: FIG. 8

Trains A, B and C are approaching station X.
Train A has halt at station X for some time (say 20 minutes).
Trains A, B, C user/system has information (through Map APIs) regarding coordinates of station X and coordinates, speed, time to reach X, stay time of train A, B, C at station X.
Adaptive cruise of Train B may adjust cruise speed of train B such that Train B reaches just after Train A leaves station X. Adaptive cruise of Train C may adjust cruise speed of train C such that Train C reaches just after Train B leaves station X. It is done as per various goals set by user discussed hereinabove.
It may help trains to reach in time and save fuel, reduce wait time outside station, reduce risk of accidents and reduce passenger rush on station.

### 20 Use Case 8: FIG. 9

Vehicle A is at point 1 and approaching station Y. Distance 1 to P=100 km.
Vehicle B is at point 2 and approaching station Y. Distance 2 to P=80 km.
Both vehicle A and B are moving at present at cruise speed 90 km/hr.
Two vehicles are to exchange goods/passengers at station Y.
Vehicle B will reach 1st and wait for Vehicle A to reach after sometime. Adaptive cruise speed system can help both reach same time if both the vehicles are having the proposed system.
Both vehicles' users have information (through Map APIs) regarding coordinates of station Y and coordinates, speed, stay time of both vehicles at station Y. Adaptive cruise system may set/advise vehicle A to adapt to new cruise speed of 100 km/hr and reach station after 1 hr from present position 1.
The system (100) set/advise vehicle B to adapt to new cruise speed of 80 km/hr and reach station after 1 hr from present position 2.
Both vehicles may reach just in time at station Y.

It may help vehicles to reach in time and save fuel, reduce wait time outside station, reduce risk of accidents and reduce passenger/goods rush on station Y. Here station Y is a junction point having connectivity in two or more directions.

FIG. 2 represents integration of the system (100) with existing cruise speed control mechanism (conventionally known). The controller (208) takes input from the microcontroller (152) or the input device (102) to set cruise speed. The controller (208) gives input to the actuator (210) which controls the throttle in combustion engine or current in motor in an electric vehicle. The engine or motor (212) further controls the speed of the wheel (214) or vehicle. Speed feedback (216) is available to the controller (208) to set or adjust the actuator (210) to cruise control speed of the vehicle. System ON/OFF display (202) may be an LED or audio signal to inform the user that system is ON or OFF. Audio/video output (204) is used to interact with users regarding cruise speed control information. Vehicle CAN (206) is similar to Vehicle CAN as the vehicle may have two or more information channels.

FIG. 3 represents two points in same geographical area having same set of conditions i.e. speed limits, road conditions, Time of the Day (TOD) charging tariff, fuel price, traffic laws, traffic flow timing restrictions, etc. User travels from starting point 1 to end point 2 for up journey. User may also opt for up and down journey i.e., round trip starting from point 1 and terminating back to point 1 after visiting point 2.

FIG. 4 represents two points in two geographical areas i.e., state A and state B having different set of conditions i.e. speed limits, road conditions, Time of the Day (TOD) charging tariff, fuel price, traffic laws, traffic flow timing restrictions, etc. P is a point on border of state A and state B. User has to travel from starting point 1 to end point 2 for up journey. User can also opt for up and down journey i.e. round trip starting from point 1 and returning back to point 1 after visiting point 2.

FIG. 5A represents four points in three geographical areas i.e., state A, state B and state C having different set of conditions i.e. speed limits, road conditions, Time of the Day (TOD) charging tariff, fuel price, traffic laws, traffic flow timing restrictions, etc. P is a point on border of state A and state B. Q is a point on border of state B and state C. User has to travel from starting point 1 to end point 2 for up journey. User can also opt for up and down journey i.e. round trip starting from point 1 and returning back to point 1 after visiting point 2.

FIG. 5B represents six points (1, 2, P, Q, R, S) in four geographical areas i.e. state A, state B, state C and state D having different set of conditions i.e. speed limits, road conditions, Time of the Day (TOD) charging tariff, fuel price, traffic laws, traffic flow timing restrictions, etc. P is a point on border of state A and state B. Q is a point on border of state B and state C. R is a point on border of state A and state D. S is a point on border of state C and state D. User has to travel from starting point 1 to end point 2 for up journey. User can also opt for up and down journey i.e. round trip starting from point 1 and returning i back to point 1 after visiting point 2. User can opt for route 1PQ2 or 1RS2 in up or down journey and the system (100) take this decision and inform the user after accounting for all parameters of interest set by user or manufacturer. OR user can do it manually after accounting for all parameters of interest set by user or manufacturer.

FIG. 6 represents three points (1, P, Q) in two geographical areas i.e. state A and state B having different set of conditions i.e. speed limits, road conditions, Time of the Day (TOD) charging tariff, fuel price, traffic laws, traffic flow timing restrictions, etc. P is a point on border of state A and state B. Q is on the border of state B and is exit point of state B. User has to travel from starting point 1 to end point Q for up journey. User can also opt for up and down journey i.e. round trip starting from point 1 and returning back to point 1 after visiting point Q.

Exemplary embodiment including Vehicle A (at point 1) and approaching point P near a station X which can be a meeting point for vehicles for goods/passenger exchange OR EV charging/fuel station OR waiting area OR parking area, as shown in FIG. 7.

Another exemplary embodiment including Vehicle A (at point 3), Vehicle B (at point 2) & Vehicle C (at point 1) are approaching point P near a station X which can be a meeting point for vehicles for goods/passenger exchange OR EV charging/fuel station OR waiting area OR parking area, as shown in FIG. 8. Vehicle can be a two, three or more-wheel vehicle on roads OR a train OR a ship OR an aeroplane OR any enclosure used to carry goods/passengers from one point to another.

Another exemplary embodiment showing Vehicle A is approaching station Y from point 1 and vehicle B is approaching station Y from opposite direction point 2, as shown in FIG. 9. Station Y is junction which has connectivity in multiple directions e.g. toward point 3 and 4 as shown in diagram. Station Y can be a meeting point for vehicles for goods/passenger exchange OR EV charging/fuel/CNG station OR waiting area OR parking area.

Various factors are used to quantify passenger load, Tyre pressure, Air conditioning, Use of vehicle, goods load with respect to given vehicle.

User has certain value of fuel or charge (for Electric Vehicle) and wants to cover certain distance without running out of fuel. Range depends on the speed of vehicle. User can change range by controlling the speed of the vehicle. User can attain desired range by getting adaptive cruise speed setting automatically or manually adjusting the cruise speed.

In another embodiment, various methods for working of the aforementioned systems are disclosed. The methods involve measuring parameters of the vehicle as aforementioned discussed and then implementing thereto depending upon different goals. The measured parameters when multiplied together, contributed to optimization of range and mileage to a large extent.

Advantages of the system (100) and the associated methods are that such systems and methods can be implemented to any type of vehicle with existing cruise control system. Such systems and methods thereof can work in online mode or offline mode. Such systems and methods thereof provide automatic and manual control of cruise speed and optimizes Range, Mileage, Fuel cost per km, Vehicular pollution, Fuel refill cost and travel time in different geographical areas depending on the vehicle characteristics, number of passengers, Tyre pressure, Air conditioning status, Use of vehicle & Load on vehicle.

As shown in FIG. 10, a flowchart depicting steps of a method (1000) for setting up “new adaptive cruise speed” of the vehicle(s) equipped with the system (100) is disclosed. The method (1000) involves receiving input comprising starting and end points of the route, followed by receiving vehicular information, receiving route information and processing thereto. The method (1000) further involves processing the input, the vehicular information, and the route information, followed by determining GPS coordinates of the vehicle with respect to the route to be followed by the vehicle, other vehicles and other point of interest enroute or otherwise. Then, the method (1000) is configured to analyse the processed input to take a decision if to set up ‘new adaptive cruise speed’ or override the ‘new adaptive cruise speed’, followed by setting the ‘new adaptive cruise speed’ automatically or as per the instructions provided by the user to override the ‘new adaptive cruise speed’ and actuating fuel supply or current supply in the vehicle in conformation with the decision. Then, the method (1000) involves controlling speed of wheels of the vehicle in conformation with the decision, followed by displaying the query for the user if to follow the ‘new adaptive cruise speed’ or override the ‘new adaptive cruise speed’, followed by displaying the selected speed accordingly.

Referring to FIG. 12, shows an exemplary display of invention features on Personal Digital Assistant (PDA) in a vehicle e.g., Multi Information Display, Infotainment system, a mobile phone etc. It is interactive input/output display where user may feed some values and some are displayed. User feeds starting and end points of a journey and are shown on the map on screen (e.g., Delhi to Jaipur). User may set Mileage, Range, Fuel cost/km, Fuel volume/km Goals for a journey. User can feed coordinates of place of meeting where other person/vehicle may meet to exchange goods or passengers. User may also feed coordinates/phone location of the person/vehicle user wants to meet. User may feed TIME IN in a geographical area and TIME OUT also. This time may be in hours or clock time (AM/PM) in given geographical area. All the six factors (PF, TPF, UF, ACF, LF, NF) discussed herein before may be fed automatically after taking input from sensors or are fed manually. Speed limit range as per local laws is marked along with speed limit violation fines. Recommended Adaptive Cruise Speed (here 60 Km/hr) is displayed which can be used by the driver for manual control and setting OR is fed to system automatically. Some other information e.g., Fuel Volume or Battery charging status is not shown in displayed format for simplicity only. There may be any parameters as aforementioned be displayed on the PDA.

It is contemplated that the aforementioned systems and methods thereof are just exemplary provided to enable persons skilled in the art to understand the present disclosure.

The foregoing descriptions of exemplary embodiments of the present disclosure have been presented for purposes of illustration and description. They are not intended to be exhaustive or to limit the disclosure to the precise forms disclosed, and obviously many modifications and variations are possible in light of the above teaching. The exemplary embodiments were chosen and described in order to best explain the principles of the disclosure and its practical application, to thereby enable others skilled in the art to best utilize the disclosure and various embodiments with various modifications as are suited to the particular use contemplated.

1. An adaptive cruise speed control assistant system for vehicle(s) comprising:
an input device to receive input comprising starting and end points of the route, vehicular information, route information, and instructions to follow adaptive cruise speed or override the adaptive cruise speed;
a battery integrated with a battery information unit to determine capacity of the battery and charging status thereof;
a fuel tank equipped with a fuel meter to determine volume of fuel and dynamic fuel level volume in the fuel tank;
a speed monitor to measure and monitor cruise speed of the vehicle;
an odometer to determine total distance covered by the vehicle “till date” to determine Use factor (UF);
a plurality of sensors comprising load sensor to monitor load status, tyre pressure monitoring sensor to determine tyre Pressure factor (PF), anti-lock brake system (ABS) speed sensors, a fuel volume sensor;
a passenger counter to count number of passengers sitting in the vehicle to determine Passenger Factor (PF);
an air conditioning status monitor to monitor heating and cooling status along with air conditioning power load to determine Air conditioning factor (ACF);
a Personal Digital Assistant (PDA) to communicate with the vehicle, a server, and other vehicles in communication with the vehicle;
a cruise speed control setup in communication with the system, the system to assist the cruise speed control setup, the system comprising:
a microcomputer having a microprocessor integrated with a plurality of modules comprising:
an input module, to receive the input;
a processing module, to process the input received from the input module;
speed analysis module, to analyse the processed input to take a decision if to set up ‘new adaptive cruise speed’ or override the ‘new adaptive cruise speed’;
speed setting module, to set the ‘new adaptive cruise speed’ automatically or as per the instructions provided by the user to override the ‘new adaptive cruise speed’; an actuating module, to actuate fuel supply or current supply in the vehicle through a controller comprising an actuator, in conformation with the decision taken by the speed analysis module; a speed controlling module, to control speed of wheels of the vehicle in conformation with the decision taken by the speed analysis module;
a vehicle information module having vehicle make, model, and speed versus mileage characteristics of the vehicle as per make and model under standard conditions stored in either memory of the microcomputer or on GPS or cloud server;
a daily fuel or charge price module having fuel or charge price information being updated daily in either memory of the microcomputer or on GPS cloud server;
a Traffic rules module comprising speed limits, traffic rules violation penalties, parking charges, TIME IN and TIME OUT permissions in given geographical area;
a display to display the query for the user if to follow the ‘new adaptive cruise speed’ or override the ‘new adaptive cruise speed’ and then displays the selected speed accordingly;
a GPS cloud server to determine GPS coordinates of the vehicle with respect to the route to be followed by the vehicle;
wherein the speed setting module adapts to set the speed basis speed versus goals comprising range, mileage, fuel running and refuel cost per km, fuel or charge refill, price, fuel volume per km, and travel distance and time restrictions compliance in different geographical areas depending upon number of factors comprising Passenger Factor (PF), Tyre Pressure factor (TPF), Use Factor (UF), Air Conditioning Factor (ACF), and Load Factor (LF) to obtain Net Factor (NF) as per vehicle make and model.

2. The system of claim 1, wherein the input device is a display with keypad to receive manual input and the user inputs starting and end points of the route manually or through voice command.

3. The system of claim 1, wherein the input device is a vehicular information unit including a connected area network (CAN) to obtain vehicular information automatically, the vehicular information comprising battery status, fuel status, Passenger Factor (PF), Tyre Pressure factor (TPF), Use Factor (UF), Air Conditioning Factor (ACF), Load Factor (LF) and Net Factor (NF).

4. The system of claim 1, wherein the route information comprises route type, specific route, alternate routes, a nearest functional fuel or charging station with fuel or charge price in a geographical area from respective sources, meeting hours, meeting IN and OUT timing schedule, time restrictions, route restrictions, and jam due to traffic, people, events, natural calamities, accidents, and road construction from start to end.

5. The system of claim 1, wherein the fuel price for the specific route or alternate routes is the latest price as per sources and vehicle make and model, and the input device fetches route information via the GPS cloud server.

6. The system of claim 1, wherein the starting and end points are in different geographical areas having conditions comprising speed limits, road conditions, Time of the Day charging tariff, fuel price, traffic laws, weather conditions, events, traffic flow timing restrictions, and traffic conditions deciding average speed, and the geographical area comprises interstate, intrastate, and inter countries.

7. The system of claim 1, wherein the vehicle(s) comprise fuel vehicles, hybrid vehicles, and electric vehicles running on land, water, in air, and space.

8. The system of claim 1, wherein the vehicle(s) comprise a single vehicle on board by the user or two or more vehicles in communication with each other through the GPS cloud server.

9. The system of claim 8, wherein two or more vehicles are configured to meet at or depart from one or more points while traveling same or different distances, including where one or more vehicles reach at “one” point and remaining vehicles depart from a different point.

10. The system of claim 1, wherein the journey comprises up, down, and round trips and the load comprises goods, vehicles, and passengers.

11. The system of claim 1, wherein a fuel goal is based on fuel availability in the fuel tank or charge availability in the battery alone or in combination, and presence of functional fuel or charging stations along direct or alternative routes.

12. The system of claim 1, wherein range goals include completing a journey without running out of fuel or charge or maximizing distance with given fuel or charge and reaching a nearest fuel or charging station under low fuel or charging warning.

13. The system of claim 1, wherein setting the ‘new adaptive cruise speed’ depends upon selection of an environment friendly route out of two or more alternative routes connecting more than one geographical area and upon achieving just-in or just-out time compliance while optimizing fuel cost and time.

14. The system of claim 1, wherein the ‘new adaptive cruise speed’ is set to complete the journey with optimization of time or mileage or fuel cost and with preference for minimum charging or fuel refilling cost in different geographical areas.

15. The system of claim 1, wherein the ‘new adaptive cruise speed’ is such that the vehicle reaches just in or out time at a fuel, charging, or CNG station to optimize waiting period or cost where fuel or charging cost varies with Time of the Day or parking cost, and coordinates between two or more vehicles and a control room thereof for the same.

16. The system of claim 1, wherein the ‘new adaptive cruise speed’ is set so as to avoid airspace congestion near airports, reduce load on Air Traffic control, avoid mid-air collisions, and reduce pollution near airports, bus stands, shipping ports, and other vehicles meeting points.

17. The system of claim 1, wherein the system is installable in existing vehicles and the fuel comprises CNG, petrol, diesel, hydrogen, biodiesel, ethanol, propane and electric energy.

18. The system of claim 1, wherein the system automatically informs, trains, and assists the user to use the vehicle, assists in optimizing speed to get more mileage, reduce running cost per km, assists in optimizing range to refill fuel or charge at reduced cost in a geographical area where cheaper refuel or recharge is available, and the charge comprises electric charge or solar charge.

19. A method for setting up “new adaptive cruise speed” of a vehicle(s) equipped with an adaptive cruise speed control assistant system (100), the method (1000) comprising:
receiving input comprising starting and end points of the route;
receiving vehicular information comprising speed versus mileage characteristics under standard constant speed conditions as per vehicle make and model, battery status, fuel status comprising fuel volume and dynamic fuel volume, Passenger Factor (PF), Tyre Pressure factor (TPF), Use Factor (UF), Air Conditioning Factor (ACF), Load Factor (LF) and Net Factor (NF) from a battery information unit (106A), a fuel tank (108), a passenger counter (116), tyre pressure monitoring sensor, an air conditioning status monitor (118), and a load sensor respectively;
receiving route information comprising route type, specific route, alternate routes, a particular nearest functional fuel or charging station from respective sources, meeting hours, meeting IN and OUT timing schedule, place coordinates, time restrictions, route restrictions, and, if any jam due to a plurality of factors comprising traffic, people, event occurrence, natural calamities, accidents, road construction in all possible routes from the starting point until the end point; processing the input, the vehicular information, and the route information;
determining GPS coordinates of the vehicle with respect to the route to be followed by the vehicle, other vehicles and other point of interest enroute or otherwise;
analysing the processed input to take a decision if to set up ‘new adaptive cruise speed’ or override the ‘new adaptive cruise speed’;
setting the ‘new adaptive cruise speed’ automatically or as per the instructions provided by the user to override the ‘new adaptive cruise speed’;
actuating fuel supply or current supply in the vehicle in conformation with the decision; controlling speed of wheels of the vehicle in conformation with the decision;
displaying the query for the user if to follow the ‘new adaptive cruise speed’ or override the ‘new adaptive cruise speed’, followed by displaying the selected speed accordingly;
wherein the method (1000) comprising adapting to set the cruise speed basis speed versus goals comprising range, mileage, fuel running and refuel cost per km, fuel or charge refill, fuel volume per km, and travel distance and time restrictions compliance in different geographical areas depending upon average of a number of factors comprising Passenger Factor (PF), Tyre Pressure factor (TPF), Use Factor (UF), Air Conditioning Factor (ACF), Load Factor (LF) and Net Factor (NF) as per vehicle make and model.

20. The method of claim 19, comprising considering latest fuel costs for the specific route or alternate routes as per sources and vehicle make and model and setting the ‘new adaptive cruise speed’ based on minimum fuel or charging/refilling cost across different geographical areas.

21. The method of claim 19, comprising enabling communication between two or more vehicles to meet at or depart from a common or different point, while traveling same or different distances, including where one or more vehicles reach at “one” point and remaining vehicles depart from a different point.

22. The method of claim 19, wherein a fuel goal is based on fuel availability in the fuel tank or charge availability in the battery alone or in combination, and presence of functional fuel or charging stations along direct or alternative routes.

23. The method of claim 19, wherein range goals include completing the journey without running out of fuel or charge and reaching a nearest fuel or charging station under a low fuel or charging warning.

24. The method of claim 19, comprising setting the ‘new adaptive cruise speed’ depending upon selection of an environment friendly route out of two or more alternative routes connecting more than one geographical area.

25. The method of claim 19, comprising setting the ‘new adaptive cruise speed’ such that the vehicle reaches just in or out time in a geographical area with restricted time entries while optimizing fuel cost and time and complying with local traffic and rules.

26. The method of claim 19, comprising setting the ‘new adaptive cruise speed’ such that the vehicle completes the journey with optimization of time or fuel cost.

27. The method of claim 19, comprising setting the ‘new adaptive cruise speed’ such that the vehicle reaches just in or out time in a fuel station or charging station or CNG station to optimize waiting period or cost wherever fuel or charging cost varies with Time of the Day or parking cost or to reduce pollution, traffic, or accidents.

28. The method of claim 19, comprising setting the ‘new adaptive cruise speed’ to avoid traffic congestion in air space near airports, reduce load on Air Traffic control systems, avoid mid-air collision, and reduce pollution near airports, bus stands, railway stations, shipping yards, and other vehicles meeting points.

29. The method of claim 19, comprising automatically informing, training, and assisting the user to use the vehicle and assisting in optimizing speed to get more mileage, reduce running cost per km and optimizing range to refill the fuel or charge at reduced cost in a geographical area where cheaper refuel or recharge is available.

30. A non-transitory computer-readable medium storing instructions which, when executed by one or more processors of an adaptive cruise speed control assistant system, cause the processor(s) to:
receive input comprising starting and end points of a route, vehicular information, and route information;
analyze vehicle parameters including speed, mileage, battery status from a battery information unit, fuel status from a fuel tank, Passenger Factor (PF) from a passenger counter, Tyre Pressure Factor (TPF) from a tyre pressure monitoring sensor, Use Factor (UF) from an odometer, Air Conditioning Factor (ACF) from an air conditioning status monitor (118), Load Factor (LF) from a load sensor, and Net Factor (NF);
determine a new adaptive cruise speed based on range, fuel or charge availability, route restrictions, cost optimization, and time-of-day conditions;
actuate a controller having an actuator to adjust fuel or current supply to conform with the determined adaptive cruise speed; and
communicate the adaptive cruise speed and control status to a display or a connected Personal Digital Assistant (PDA) for confirmation or override by the user;
wherein the new adaptive cruise speed is adapted dynamically based on speed versus goals comprising range, mileage, refuel or recharge cost per kilometer, and travel distance or time compliance in different geographical areas depending upon the average of Passenger Factor (PF), Tyre Pressure Factor (TPF), Use Factor (UF), Air Conditioning Factor (ACF), Load Factor (LF), and Net Factor (NF) as per vehicle make and model.

31. The computer-readable medium of claim 30, wherein determining the new adaptive cruise speed comprises comparing stored speed-versus-mileage characteristics from a vehicle information module with live sensor data received from the vehicular information unit.

32. The computer-readable medium of claim 30, wherein the processor(s) further transmit adaptive cruise data to a GPS cloud server for logging or fleet analytics.

33. A vehicle comprising:
a propulsion system;
a plurality of sensors including a battery information unit, a fuel meter associated with a fuel tank, a tyre pressure monitoring sensor, a passenger counter, and a load sensor;
a control unit in communication with the sensors; and
an adaptive cruise speed control assistant system configured to:
receive route and vehicular information via an input device;
analyze the vehicular parameters to determine a new adaptive cruise speed based on a Net Factor (NF) derived from Passenger Factor (PF), Tyre Pressure Factor (TPF), Use Factor (UF), Air Conditioning Factor (ACF), and Load Factor (LF); and
control the propulsion system of the vehicle by actuating a controller having an actuator in conformation with the determined adaptive cruise speed;
wherein the adaptive cruise speed control assistant system adapts to maintain an optimized speed profile to complete the journey with compliance to travel time restrictions, minimum fuel or charge cost, and mileage optimization under varying geographical conditions using data from a GPS cloud server.

34. The vehicle of claim 33, wherein the adaptive cruise speed control assistant system (100) further selects an environmentally friendly route among multiple alternatives to minimize fuel or charging cost and travel time using data from a GPS cloud server.

35. The vehicle of claim 33, wherein the vehicle comprises an electric, hybrid, or hydrogen-powered vehicle, and the adaptive cruise speed control assistant system coordinates fuel or charge refilling based on cost and station availability along the route.

36. A system for coordinated adaptive cruise control among multiple vehicles, comprising:
a plurality of adaptive cruise speed control assistant systems, each installed in a respective vehicle and configured to communicate via a shared GPS cloud server;
wherein each system exchanges position, speed, and route data with other vehicles to synchronize adaptive cruise speeds such that meeting or departure points are optimized for time, fuel or charge cost, and traffic-law compliance across the fleet;
wherein the synchronization further adapts to ensure that vehicles reach refueling or charging points at just-in or just-out times, minimize idle durations, balance route density, and collectively reduce emissions or congestion within the coordinated geographical area.

37. The system of claim 36, wherein synchronization includes adjusting speed such that two or more vehicles reach a common refueling or charging station at just-in or just-out time to minimize waiting or cost, and coordinates through respective controllers (208) in each vehicle.

38. The system as claimed in claim 36, wherein the shared GPS cloud server (126) further provides aggregated analytics on mileage efficiency, congestion reduction, and emissions optimization across the coordinated vehicles.
